(19) United States
(12) Patent Application Publication
(10) Pub. No.: US 2026/0067851 A1
(43) Pub. Date: Mar. 5, 2026

(54) APPARATUS AND METHODS FOR MONITORING TRAINED MACHINE LEARNING PROCESSES ASSOCIATED WITH POSITIONING DETERMINATIONS

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 19/107,002

(22) PCT Filed: Sep. 11, 2023
(86) PCT No.: PCT/US2023/073852

§ 371 Date: Feb. 26, 2025

(30) Foreign Application Priority Data
Nov. 1, 2022 (GR) 20220100882

(51) Int. Cl. H04W 64/00; H04L 5/00

(52) U.S. Cl. CPC H04W 64/00; H04L 5/0051

(57) ABSTRACT

Methods, systems, and apparatuses to monitor or configure one or more user equipment (UE). For example, a computing device may, transmit a reporting request for positioning data to a user equipment. Additionally, the computing device may, receive reporting data indicative of a comparison between first positioning data generated from a first process and second positioning data generated from a second process. Further, the computing device may, based on the reporting data, generate and transmit, to the user equipment, an instruction that causes the user equipment to implement the first process.

### FIELD OF DISCLOSURE

The disclosed embodiments generally relate to monitoring trained machine learning processes.

### BACKGROUND

Wireless communication systems can provide various telecommunications services including, for example, audio, video, data, messaging, and network access, among other others. For instance, wireless communication systems may allow for communications among various devices, such as Internet of Things (IoT) devices. These wireless communication systems can be based on various technologies, such as code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TDSCDMA) systems, Long Term Evolution (LTE) systems, WiMax systems, and Evolved High Speed Packet Access (HSPA+) systems. These and other wireless communication systems may conform to a standard, such as the third generation (3G) of broadband cellular network technology, the fourth generation (4G) of broadband cellular network technology, and more recently the fifth generation (5G) of broadband cellular network technology (also known as New Radio (NR)).

A wireless communication system may include a number of base stations (BSs) and a number of user equipment (UE). In some examples, the BS may enable wireless communications for the number of UE. Additionally, the wireless communication system may also provide location services. For instance, the wireless communication system may include a location management function (LMF) that can provide location services to the number of UE.

### SUMMARY

According to one aspect an apparatus may comprise a non-transitory, machine-readable storage medium storing instructions, and at least one processor coupled to the non-transitory machine-readable storage medium. The at least one processor may be configured to transmit a reporting request for positioning data to a user equipment. In some examples, the reporting request may cause the user equipment to perform operations in a first mode. In some instances, the operations may include implementing a first process to generate first positioning data, and implementing a second process to generate second positioning data, and generating reporting data indicative of a comparison between the first positioning data and the second positioning data. Additionally, the at least one processor may be configured to receive, from the user equipment, the reporting data. Further, the at least one processor may be configured to, based on the reporting data, generate and transmit, to the user equipment, an instruction, wherein the instruction causes the user equipment to implement at least one of the first process or the second process.

According to another aspect to another aspect a non-transitory, machine-readable storage medium storing instructions that, when executed by at least one processor of a location server, causes the at least one processor to perform operations that include transmitting a reporting request for positioning data to a user equipment. In some examples, the reporting request may cause the user equipment to perform operations in a first mode. In some instances, the operations of the first mode may include implementing a first process to generate first positioning data, and implementing a second process to generate second positioning data, and generating reporting data indicative of a comparison between the first positioning data and the second positioning data. Additionally, the operations may include receiving, from the user equipment, the reporting data. Further, the operations may include, based on the reporting data, generate and transmit, to the user equipment, an instruction, wherein the instruction causes the user equipment to implement at least one of the first process and or second process.

According another aspect, a computer-implemented method includes transmitting a reporting request for positioning data to a user equipment. In some examples, the reporting request may cause the user equipment to perform operations in a first mode. In some instances, the operations of the first mode may include implementing a first process to generate first positioning data, and implementing a second process to generate second positioning data, and generating reporting data indicative of a comparison between the first positioning data and the second positioning data. Additionally, the computer-implemented method may include receiving, from the user equipment, the reporting data. Further, the computer-implemented method may include, based on the reporting data, generate and transmit, to the user equipment, an instruction, wherein the instruction causes the user equipment to implement at least one of the first process and or second process.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary wireless communication system, in accordance with some exemplary embodiments;

FIGS. 2-6 are block diagrams illustrating a portion of an exemplary wireless communication system, in accordance with some exemplary embodiments;

FIG. 7 is a flowchart of an exemplary process 700 for determining a performance of a process deployed by UE 104; and

FIG. 8 is a flowchart of an exemplary process 800 for generating reporting data, in accordance with some exemplary embodiments.

Like reference numbers and designations in the various drawings indicate like elements.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein are directed to a wireless communication system that includes a computing device or system and a number of user equipment (UE). Such embodiments may enable a computing device or system to monitor a performance of a particular process implemented on one or more of the number of UE. Additionally, while the computing device or system monitors the performance of the particular process implemented on each of the one or more UE, each of the one or more UE may be configured to implement a first or reporting mode. When the corresponding UE is in the first mode, the UE may generate a first data, such as first measurement data, associated with the particular process and a second data, such as second measurement data, associated with a legacy process. Moreover, the computing device or system may determine a performance of the particular process based in part on the first data and the second data. Further, based on the performance of the particular process, the computing device or system may modify or change the configuration of one or more UE, such as causing the one or more UEs to operate in a second mode instead of the first mode. In some instances, while the corresponding UE is operating in the second mode, the corresponding UE may implement another process to generate third data, such as third measurement data. In such instances, the third data, may be utilized by the computing device or system to provide location services for the corresponding UE.

### A. Exemplary Wireless Communication System

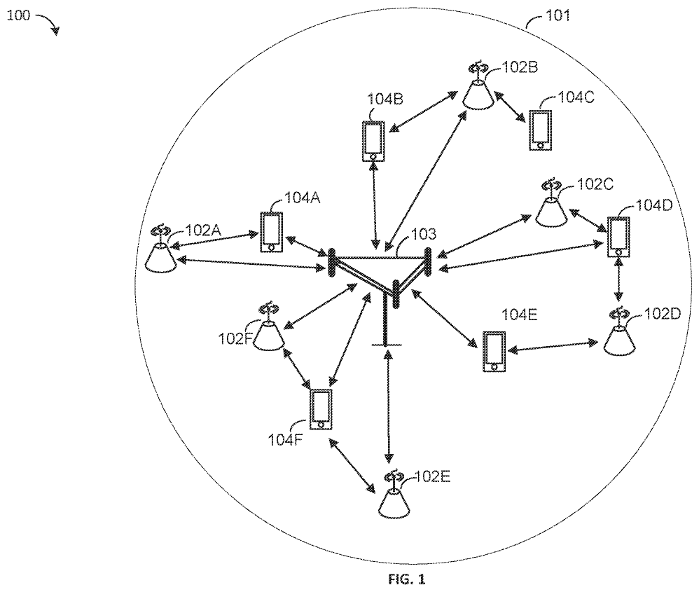

FIG. 1 illustrates a block diagram of an example wireless communication system 100, such as a 5G wireless communication system, that includes among other things, one or more computing systems, such as location management function (LMF) computing system 102A, LMF computing system 102B, LMF computing system 102C, LMF computing system 102D, LMF computing system 102E, and LMF computing system 102F, at least one base station (BS) 103, and one or more user equipment (UE) 104, such as UE 104A, UE 104B, UE 104C, UE 104D, UE 104E, and UE 104F. Each of the one or more computing systems, such as LMF computing system 102, and the one or more UE 104 may each be operatively connected to, and interconnected across, one or more communications networks. Although, wireless communication system 100 may include additional components, such as access and mobility management functions (AMFs), session management functions (SMF), relay stations, and any other suitable components, they are not illustrated for simplicity purposes. Additionally, although wireless communication system 100 may only illustrate one BS 103, six LMF computing systems 102 and six UE 104, wireless communication system 100 may include any number of a LMF computing systems 102, BS 103 and UE 104.

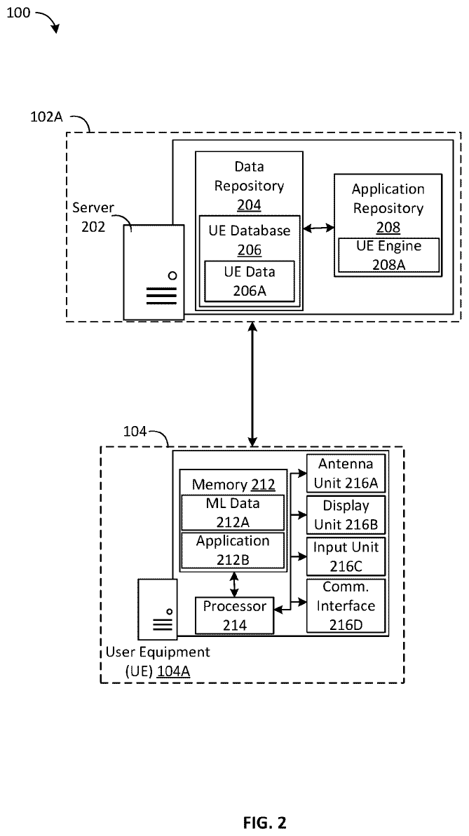

LMF computing system 102, such as LMF computing system 102A, LMF computing system 102B, LMF computing system 102C, LMF computing system 102D, LMF computing system 102E, and LMF computing system 102F, may each represent a computing system that includes one or more servers, such as server 202, and one or more tangible, non-transitory memory devices storing executable code, application engines, or application modules. Each of the one or more servers may include one or more processors, which may be configured to execute portions of the stored code, application engines or modules, or application programs to perform operations consistent with the disclosed exemplary embodiments. For example, referring to FIG. 2, the one or more servers of LMF computing system 102A may include server 202 having one or more processors configured to execute portions of the stored code, application engines or modules, or application programs maintained within the one or more tangible, non-transitory memories.

In some instances, LMF computing system 102 may correspond to a discrete computing system, although in other instances, LMF computing system 102 may correspond to a distributed computing system having multiple, computing components distributed across an appropriate computing network. Further, LMF computing system 102 may also include one or more communications interfaces, such as one or more wireless transceivers, coupled to the one or more processors for accommodating wired or wireless internet communication across a communications network with other computing systems and devices operating within wireless communication system 100 (not illustrated in FIG. 1), such as additional components of wireless communication system 100, such as access and mobility management functions (AMFs), session management functions (SMF), relay stations, and any other suitable components.

In some examples, LMF computing system 102 may be associated with a wireless communication service provider, and may be operated by one or more operators of the wireless communication service provider. Additionally, LMF computing system 102 may be configured to provide support location services to each of the one or more UE 104. For example, referring to FIG. 1, LMF computing system 102A may receive, from UE 104A, measurement data of each beam transmitted by BS 103 and detected by UE 104A. In some instances, each element of the measurement data may include measurement information of the detected beam determined by the corresponding UE 104. Additionally, the measurement information may be associated with a particular data or attribute (e.g., assistance data, positioning frequency layer (PFL) ID(s), positioning reference signal (PRS) resource ID, TRP, PRS resource set ID, timestamp, etc.). Examples of measurement information that may be included in the measurement data include, reference signal time difference (RSTD), received signal received power (RSRP), reference signal received power path (RSRPP), time difference of receive and transmit measurement values (Rx-Tx), and information characterizing a location estimate of the corresponding UE 104, such as UE 104A. Based on the measurement data of each of the one or more UE 104, LMF computing system 102 may provide location services to the corresponding UE 104, such as generating and transmitting assistance data to UE 104A. The assistance data may include, for example, reference times, reference locations, ionospheric models, earth orientation parameters, time offsets, differential corrections, Ephemeris and Clock Models, health status, data bit assistance, acquisition assistance, almanac, UTC models, and carrier phase data. In some instances, one or more UE 104 may request location services, such as the assistance data, from LMF computing system 102. In such instances, LMF computing system 102 may provide the location services to each of the one or more UE 104 that requested the location services.

In other examples, LMF computing system 102 may monitor a performance of a new process implemented by one or more of a number of UE 104. Additionally, LMF computing system 102 may monitor the performance of the new process based on measurement data associated with the new process and measurement data associated with a legacy process. In such examples, each of the one or more UE 104 may implement the new process and the legacy process to generate the measurement data associated with the new process and the legacy process. In some instances, LMF computing system 102 determines the performance of the new process by comparing the measurement data of the new process to the measurement data of the legacy process. Additionally, LMF computing system 102 may determine a difference between the measurement data of the new process to the measurement data of the legacy process, and whether the difference exceeds a difference threshold or is below a quality/standard threshold. In examples where LMF computing system 102 determines the difference between the measurement data of the new process to the measurement data of the legacy process above a quality or difference threshold (e.g., below a predetermined standard), LMF computing system 102 may modify or change the configuration of one or more UE 104. In some instances, the new process may be associated with a trained machine learning process. In other instances, the legacy process may be associated with a trained machine learning process.

By way of example and referring to FIG. 2, to facilitate the performance of one or more of these exemplary processes, LMF computing system 102, such as LMF computing system 102A, may maintain within the one or more tangible, non-transitory memories, data repository, such as data repository 204 that includes, but is not limited to, UE data store, such as UE data store 206. As illustrated in FIG. 2, the UE data store, such as UE data store 206 may store a UE dataset of each of one or more UE 104 that are in communication with LMF computing system 102. As described herein, the UE datasets of each of the UE 104, such as UE data 206A associated with UE 104A, may include data identifying the corresponding UE 104 (e.g., a corresponding serial number or an identifying number), data identifying one or more processes that may be implemented by the corresponding UE 104 (e.g., a new first trained machine learning process and a second legacy trained machine learning process), data including parameters of each of the one or more processes, such as model parameters, and data indicating a performance status of the one or more processes. In some instances, examples of the performance status of the one or more processes includes, a performance status that indicates the performance of a particular process is below a predetermined standard, and a performance status that indicates the performance of a particular trained machine learning process is below a predetermined standard.

Further, and to facilitate the performance of any of the exemplary processes described herein, LMF computing system 102, such as LMF computing system 102A, may include one or more servers, such as server 202, that may also maintain within the one or more tangible, non-transitory memories, an application repository, such as application repository 208. By way of example, application repository 208 (or any application repository of any LMF computing system 102) may maintain, among other things, UE engine 208A. UE engine 208A may initiate the monitoring of the performance of one or more processes implemented by each of the one or more UE 104 by generating and transmitting (e.g., broadcasting), a reporting request to each of the one or more UE 104. In some examples, the reporting request may include parameter data identifying one or more monitoring parameters. In some instances, in accordance with the one or more monitoring parameters, each of the one or more UE 104 may generate measurement data, from a particular process, such as a new and trained machine learning process, and a legacy process, that may be comparable for purposes of determining a performance of the particular process. For instance, each measurement data generated from the particular process and the legacy process, may each include the same type of data or attribute and with matching or similar timestamps. Further, each of the one or more UE 104 may generate, based on the comparable measurement data of the particular process and the measurement data of the legacy process, reporting data that indicates a performance of a particular process.

In some examples, the one or more monitoring parameters of the parameter data may include a timing parameter. The timing parameter may indicate a period of time a corresponding UE 104 may implement a process to be monitored and a legacy process so that the generated corresponding measurement data may have elements with timestamps that match or are within a predetermined time threshold or margin. In such examples, the process to be monitored, such as a new and trained machine learning process, and the legacy process, such as a trained legacy machine learning process, may each have differing measurement period configurations and may detect and determine measurements at different time intervals (e.g., RAN 4 requirements). As such, the timing parameter may indicate an extended measurement period for both the process to be monitored and the legacy process (e.g., extending RAN 4 requirements). That way, one or more elements of measurement data of the process to be monitored and the one or more elements of measurement data of the legacy process may have matching timestamps or timestamps that are within a predetermined time threshold or margin. In other examples, the one or more monitoring parameters of the parameter data may include a model or process parameter. The model or process parameter may identify a particular process LMF computing system 102 may monitor or model UE 104 may implement.

In various examples, the one or more monitoring parameters of the parameter data may include a resource parameter. The resource parameter may identify one or more resources, attributes or data the corresponding UE 104 may measure from one or more detected beams transmitted from BS 103. In some instances, such resources, attributes, or data may be associated with assistance data, PFL ID(s), PRS resource ID, TRP, and PRS resource set ID. Further, based on the resource parameter, UE 104 may implement a process to be monitored and a legacy process that each generates measurement data including measurements or measurement information of the same resource, attribute or data. For example, based on the resource parameter, UE 104 may implement a process to be monitored along with the legacy process that each generate measurement data including data identifying a RSTD. In other instances, the resource parameter may identify a subset of resources, attributes, or data the corresponding UE 104 may measure from one or more detected beams transmitted from BS 103, such as a subset of TRP resources. In such instances, based on the resource parameter, UE 104 may implement at least two processes including a process to be monitored, and a legacy process, where each process generates measurement data (e.g., measurements, measurement information) of the same subset of resources, attributes or data.

In various instances, the resource parameter may identify a first subset of resources, attributes, or data and a second set of resources, attributes, or data that the corresponding UE 104 may measure from one or more beams transmitted from BS 103. Additionally, the resource parameter may indicate which process, such as the process to be measured or the legacy process, is to generate measurement data associated with which subset of resources (e.g., the first subset of resources or the second subset of resources). For instance, the resource parameter may indicate the first subset of resources is associated with a legacy process, where the first subset of resources includes TRPs such as reference TRPs, line-of-sight (LOS) heavy TRPs, non-line-of-sight (NLOS) TRPs, serving TRPs, or any combinations thereof. Additionally, the resource parameter may indicate that the second subset of resources is associated with a process to be measured. For example, the second set of resources may include resources, attributes, or data associated with assistance data, PFL IDs, PRS resource IDs, TRPs, PRS resource set IDs, PRS resources, or any combinations thereof. Moreover, and based on the resource parameter, UE 104 may implement the legacy process to generate measurement data of the first subset of resources, attributes, or data, and the process to be monitored to generate measurement data of the second subset of resources, attributes, or data.

In some examples, the parameter data of a reporting request may be associated with a particular positioning method (e.g., UE assisted or UE based). In such examples, the measurement data may then be associated with the positioning method the parameter data is associated with. For example, a reporting request may include parameter data associated with a Multi-RTT positioning method. In such an example, the corresponding UE 104 may implement a first process that is to be monitored and a second legacy process that both generate measurement data associated with the Multi-RTT positioning method. For instance, the measurement data may include data identifying UE Rx-Tx, RSRP, and/or RSRPP for each of the first process and the second legacy process. In yet another example, the reporting request may include parameter data associated with a DL-AoD positioning method. In such an example, the corresponding UE 104 may implement a process that is to be monitored and a second legacy process that both generate measurement data associated with DL-AoD positioning method. For instance, the measurement data may include data identifying RSRP, and/or RSRPP. In another example, the reporting request may include parameter data associated with a UE based positioning method. In such an example, the corresponding UE 104 may implement a process that is to be monitored and a second legacy process that both generate measurement data associated with the positioning method. For instance, the measurement data may include data identifying and characterizing a location estimate of the UE.

Additionally, as illustrated in FIG. 2, UE engine 208A may modify or change the configuration of one or more UE 104 based on measurement data of a process being monitored and measurement data of the legacy process. For example, UE engine 208A may receive reporting data generated by each of the one or more UE 104. The reporting data may indicate a performance of the process being monitored. In some instances, the reporting data may indicate whether the performance of the process is above a predetermined standard or below a quality threshold. In examples where UE engine 208A determines, based on the reporting data, the performance monitored process is below a quality/standard threshold, UE engine 208A may modify or change the configuration of a corresponding one or more UE 104. For instance, the reporting data may indicate a difference between the measurement data of the new process to the measurement data of the legacy process exceeds a difference threshold. In examples where UE engine 208A determines, based on the reporting data, the difference between the measurement data of the new process to the measurement data of the legacy process exceeds a difference threshold, UE engine 208A may modify or change the configuration of one or more UE 104.

In some instances, the reporting data may include first measurement data generated by the particular process being monitored as well as raw data of a second measurement data generated by another process being used to determine the performance of the particular process. In such instances, LMF computing system 102, such as LMF computing system 102A may process the raw data of the second measurement data to determine whether the accuracy of the first measurement data and the performance of the particular process being monitored. For example, LMF computing system 102 may obtain reporting data of UE 104, such as UE 104A. The reporting data may include measurement data of a first trained machine learning process that was applied by UE 104 to a detected beam transmitted from BS 103. The measurement data may include data characterizing and identifying a location estimate of the UE 104. Additionally, the reporting data may include raw measurement data of a second legacy process that was applied by UE 104 to the detected beam transmitted from BS 103. Based on the raw measurement data of the second legacy process, LMF computing system 102 may determine a location estimate of the UE derived from the raw measurement data of the second legacy process. Further, LMF computing system 102 may compare the location estimate of the first trained machine learning process to the location estimate determined from the second legacy process to determine the accuracy and the performance of the first trained machine learning process. Based on such determinations, LMF computing system 102 may modify or change the configuration of UE 104. For instance, LMF computing system 102 may determine a difference between a value associated with the location estimate of the first trained machine learning process to a value associated with the location estimate determined from the second legacy process. Additionally, LMF computing system 102 may determine whether the determined difference exceeds a difference threshold. In response to LMF computing system 102 determining the determined difference exceeds the difference threshold, LMF computing system 102 may modify or change the configuration of UE 104 (e.g., operating in a mode to utilize the second legacy process or another process instead of the first trained machine learning process to generate measurement data). Otherwise, in examples where the determined difference is at or below the difference threshold, LMF computing system 102 may enable UE 104 to continue implementing the first trained machine learning process to generate measurement data.

Referring to FIG. 1, BS 103, which may also be referred to as a Node B, a gNB, a transmit receive point (TRP), an access point (AP), and the like, may provide communication coverage for a particular geographical area, such as geographical area 101. For example, geographical area 101 may correspond to a macro cell, a pico cell, a femto cell, or any other type of cell. To provide coverage, BS 103 may transmit one or more beams that cover at least portions of geographical area 101. Each beam may include one or more carriers that operate within a frequency spectrum. For example, BS 103 may transmit data, such as PRS, within downlink transmissions to one or more UE 104 using the one or more carriers associated with each beam.

Additionally, each of UE 104, such as UE 104A, UE 104B, UE 104C, UE 104D, UE 104E and UE 104F may each detect one or more beams transmitted from BS 103. Further, each of UE 104 may deploy one or more processes on the detected one or more beams to generate corresponding measurement data. Referring to FIG. 2, to facilitate the performance of one or more of these exemplary processes, each of the UE 104, such as UE 104A, may include a computing device having one or more tangible, non-transitory memories, such as memory 212, that store data and/or software instructions, and one or more processors, such as processor 214, configured to execute the software instructions. The one or more tangible, non-transitory memories may, in some aspects, store application programs, application engines or modules, and other elements of code executable by the one or more processors, such as, but not limited to, an executable web browser (e.g., Google Chrome™, Apple Safari™, etc.), and additionally or alternatively, an executable application associated with wireless communication system 100 (e.g., application 212B). In some instances, not illustrated in FIG. 2, memory 212 may also include one or more structured or unstructured data repositories or databases, and each of the UE 104 may maintain one or more elements of device data within the one or more structured or unstructured data repositories or databases. For example, the elements of device data may uniquely identify UE 104 within wireless communication system 100, and may include, but are not limited to, an Internet Protocol (IP) address assigned to UE 104 or a media access control (MAC) layer assigned to UE 104.

Each of the UE 104 may include an antenna unit, such as antenna unit 216A, configured to detect and/or receive data transmissions or beams/resources from at least BS 103. In some examples, the antenna unit may include one or more antenna and each of the one or more antenna may detect the one or more beams transmitted from BS 103. As described herein, each of the UE 104 may determine one or more measurements associated with each beam or resource transmitted from BS 103, such as RSTD, RSRPP, RSRP, time difference of receive and transmit measurement values, and a location estimate of the corresponding UE 104. Additionally, each UE 104 may include a display unit, such as display unit 216B, configured to present interface elements to a corresponding user, such as a user of the UE 104, and an input unit, such as input unit 216C, configured to receive input from the user (e.g., in response to the interface elements presented through the display unit). By way of example, the display unit may include, but is not limited to, an LCD display unit or other appropriate type of display unit, and input unit 216C may include, but is not limited to, a keypad, keyboard, touchscreen, voice activated control technologies, or appropriate type of input unit. Further, in additional aspects (not illustrated in FIG. 1), the functionalities of the display unit and input unit may be combined into a single device, e.g., a pressure-sensitive touchscreen display unit that presents interface elements and receives input from user. Further, each of UE 104 may also include a communications interface, such as communications interface 216D, such as a wireless transceiver device, coupled to a processor of the corresponding UE 104, such as processor 214, and configured by the processor to establish and maintain communications with a communications network via one or more communication protocols, such as WiFi®, Bluetooth®, NFC, a cellular communications protocol (e.g., LTE®, CDMA®, GSM®, etc.), or any other suitable communications protocol.

Examples of UE 104 (e.g., UE 104A, UE 104B, UE 104C) may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 216B. In some examples, UE 104 may be a vehicle. In other examples UE 104 may be an autonomous vehicle (e.g., a vehicle with autonomous driving capabilities). In some instances, UE 104 may also establish communications with one or more additional computing systems or devices operating within wireless communication system 100 across a wired or wireless communications channel (for example, via the communications interface using any appropriate communications protocol).

In some examples, each of the UE 104 may perform operations to determine measurements of a detected one or more beams transmitted by BS 103. Additionally, each of UE 104 may generate measurement data based on the determined measurements. For instance, each element of the measurement data may include measurement information of the determined measurements at a particular point in time that the measurement was taken. Further, each element may be associated with a timestamp generated by the corresponding UE 104. The timestamp may indicate the particular point in time when the measurement was taken. In some examples, each UE 104 may implement UE assisted or UE based positioning methods, such as multi-cell round trip time (multi-RTT) positioning, downlink time difference of arrival (DL-TDOA) positioning, and downlink angle of departure (DL-AoD) positioning methods, to determine such measurements or to generate such measurement data. For example, while BS 103 is operating in a wireless communication system such as New Radio (NR), one or more UE 104, such as UE 104A, UE 104B and UE 104C may implement UE assisted or UE based positioning methods, such as multi-cell round trip time (multi-RTT) positioning, downlink time difference of arrival (DL-TDOA) positioning, and downlink angle of departure (DL-AoD) positioning methods, to generate measurement data. In various instances, the measurement data may be utilized by LMF computing system 102 to communicate additional data, such as assistance data, that each of the one or more UE 104 may utilize to determine its own position.

In some instances, each of the UE 104 may operate in a normal or first mode associated with normal operations. While each of the UE 104 are operating in the first mode, the corresponding UE 104, such as UE 104A may perform operations to determine measurements of a detected one or more beams transmitted by BS 103 by utilizing a process associated with the first mode. In some examples, the process may be a newly deployed trained machine learning process.

In other instances, each of the UE 104 may be configured to deploy or implement multiple processes for the purpose of determining a performance of one of the multiple processes. In such instances, each of the UE 104 may implement or operate in a mode associated with determining a performance of one of the multiple processes by comparing data, such as measurement data generated from the one process and another process, such as a legacy process. For instance, a particular UE 104, such as UE 104A may be configured to deploy a first trained machine learning process and a second trained machine learning process. In such an instance, first trained machine learning process and the second trained machine learning process are both associated with determining measurements and/or generating measurement data of one or more beams transmitted from BS 103. Additionally, while the particular UE 104 is operating in a second mode, UE 104 may implement first trained machine learning process to generate first measurement data and the second trained machine learning process to generate second measurement data. Based on the first measurement data and the second measurement data, the particular UE 104 may determine a performance of the first trained machine learning model. In some instances, a process utilized by one or more UE 104 to determine a performance of another process may be designated as a legacy process by an operator of wireless communication system 100.

In various instances, one or more UE 104 may determine a performance of a particular process based on a quality or standard threshold. For instance, a particular UE 104, such as UE 104A may be configured to deploy a first trained machine learning process to generate first measurement data of a beam transmitted from BS 103 and a second trained legacy machine learning process to generate second measurement data of the beam. Additionally, first trained machine learning process may be identified by LMF computing system 102 as the process to be monitored, and the quality or standard threshold may be a predetermined difference threshold that if exceeded, may indicate that the performance of first trained machine learning process is poor. Moreover, the particular UE 104 may determine a difference between a value of a least one element or measurement of the first measurement data and a value of a least one element or measurement of the second measurement data, and compare the determined difference against the predetermined difference threshold. In examples where the determined difference exceeds the predetermined difference threshold, the particular UE 104 may determine that the first trained machine learning process is performing below a quality/standard threshold. In examples where the determined difference matches or is below the predetermined difference threshold, the particular UE 104 may determine that the first trained machine learning process is performing at or above a quality/standard threshold, respectively.

In examples where the particular UE 104 determines a process identified as the process to be monitored, such as a first trained machine learning process, is performing below a quality/standard threshold, UE 104 may transmit, to LMF computing system 102, reporting data indicating that the monitored process is performing below the quality/standard threshold. In such examples, LMF computing device 102 may modify or change the configuration of the particular UE 104. For example, based on the reporting data, LMF computing system 102 may cause the particular UE 104 to operate in a third mode. In some instances, while the particular UE 104 is operating in a third mode, the particular UE 104 may utilize the process utilized to determine the performance of the monitored process, such as the second trained legacy machine learning process, or another process that an operator of the wireless communication system 100 has designated as robust and reliable, such as a third trained legacy machine learning process. For instance, in response to LMF computing device 102 determining, based on the reporting data, the monitored process is performing below the quality/standard threshold, LMF computing device 102 may cause the particular UE 104 to operate in a third mode and automatically utilize the process utilized to determine the performance of the monitored process, such as the second trained legacy machine learning process, or the other process that an operator of the wireless communication system 100 has designated as robust and reliable, such as a third trained legacy machine learning process, instead of the monitored process.

In examples where the particular UE 104 determines a process identified as the process to be monitored, such as a first trained machine learning process, is performing at or above a quality/standard threshold, UE 104 may transmit, to LMF computing device 102, reporting data indicating that the monitored process is performing at or above the quality/standard threshold. In such examples, LMF computing system 102 may cause the particular UE 104 to implement the process that was monitored to generate measurement data. As such, LMF computing system 102 may provide location services to the particular UE 104 based on the measurement data associated with the process that was monitored. In some examples, the particular UE 104 may determine a process identified as the process to be monitored, such as a first trained machine learning process, is performing at or above a quality/standard threshold. In such examples, the particular UE 104 may not generate and/or transmit, to LMF computing system, reporting data indicating the monitored process is performing at or above the quality/standard threshold. Instead, the particular UE 104 may automatically start implementing just the monitored process to generate measurement data that LMF computing system 102 may utilize to provide location services to the particular UE 104

In some instances, UE 104 may fall back to a default, safe or third mode automatically and without receiving an instruction from LMF computing device 102, upon UE 104 determining a monitored process, such as a first trained machine learning process, is performing below a quality/standard threshold. For instance, a particular UE 104, such as UE 104A, may determine a first trained machine learning process is performing below a quality/standard threshold based on measurement data of the first trained machine learning process and measurement data of a second legacy process, such as a second trained legacy machine learning process. Upon UE 104 determining the first trained machine learning process is performing below a quality/standard threshold, UE 104 may automatically fall back to and operate in a default, safe or third mode. In such an instance, the UE 104 may automatically fall back to and operate in the default, safe or third mode without communicating with LMF computing system 102. Additionally, while UE 104 is operating in the default, safe or third mode, UE 104 may deploy the process utilized to determine the performance of the monitored process, such as the second trained legacy machine learning process, or another process that an operator of the wireless communication system 100 has designated as robust and reliable, such as a third trained legacy machine learning process, to determine measurements from a detected one or more beam transmitted from BS 103.

In various instances, each of the UE 104 may determine measurements and/or generate measurement data associated with one or more beams detected by the corresponding UE 104 and transmitted by BS 103, in accordance with one or more monitoring parameters included a reporting request received from LMF computing system 102. For example, LMF computing system 102 may transmit a reporting request to one or more UE 104, such as UE 104A. As described herein, the reporting request may include parameter data and the parameter data may include one or more monitoring parameters including a timing parameter, a resource parameter, and a model parameter. In some examples, the reporting request may include data characterizing the quality/standard threshold, such as a value of the difference threshold. Additionally, in accordance with the one or more monitoring parameters, the one or more UE 104 may determine which process to monitor (based on the model parameter), resources, attributes or data to measure from one or more detected beams transmitted from BS 103 (based on the resource parameter), and a measurement time interval or period (based on the timing parameter). Moreover, based on such determinations, the one or more UE 104 may implement the identified process, such as a first trained machine learning process, to make such measurements and generate corresponding measurement data. Further, the one or more UE 104 may implement another or second process that generates measurement data that may be utilized to determine the performance of the identified process to be monitored. For instance, the one or more UE 104 may implement a second process, such as a second trained legacy machine learning process, to make measurements and generate corresponding measurement data associated with the one or more detected beams transmitted from BS 103, in accordance to the timing parameter and the resource parameter. In some instances, the process or model parameter may also identify the other or the second process.

### B. Computer-implemented Techniques for Updating a Machine Learning Process

As described herein, LMF computing system 102, such as LMF computing system 102A, LMF computing system 102B, LMF computing system 102C, LMF computing system 102D, LMF computing system 102E, and LMF computing system 102F, may each be configured to monitor a new process, such as a first trained machine learning process, implemented by one or more UE 104, such as UE 104A, UE 104B, UE 104C, UE 104D, UE 104E, and UE 104F. Additionally, a LMF computing system 102 may determine a performance of the new process based on measurement data of the new process, as well as measurement data of a second process. As described herein, the second process may be a trained legacy machine learning process.

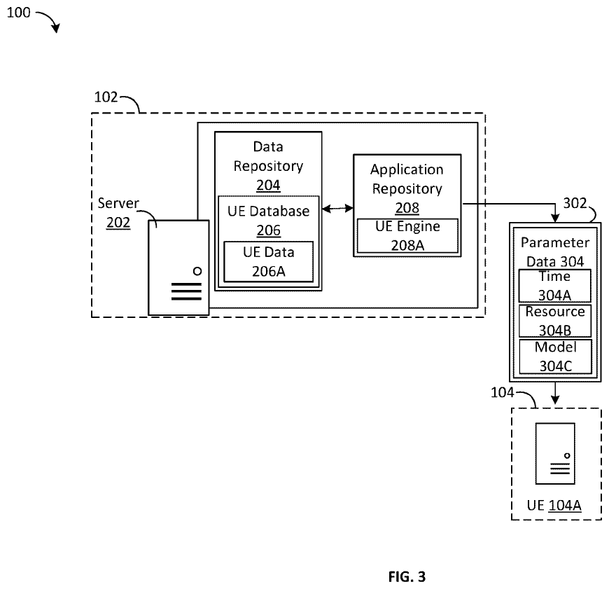

Referring to FIG. 3, executed UE engine 208A may perform operations that generate reporting request 302 that includes parameter data 304. As illustrated in FIG. 3, parameter data 304 may include one or more monitoring parameters, such as timing parameter 304A, resource parameter 304B and modelling or processing parameter 304C. As described herein, the one or more parameters, such as timing parameter 304A (e.g., a parameter that indicates a period of time or a measurement period a corresponding UE 104 makes measurements from the new process and the legacy process), resource parameter 304B (e.g., a parameter that identifies one or more resources, attributes or data the corresponding UE 104 may measure from one or more detected beams transmitted from BS 103) and modelling or processing parameter 304C (e.g., a parameter that at least identifies a process to monitor, such as the new process, and may identify the second process, such as the legacy process, that generates the measurement data to compare the measurement data of the monitored process to) may enable each of one or more UE 104, such as UE 104A to generate measurement data, from the new process (e.g., the first new and trained machine learning process) and the second process (e.g., the legacy process). Additionally, the measurement data associated with the new process and the measurement data associated with the second process may be compared, by UE 104 and/or LMF computing system 102, to determine a performance of the new process.

For example, executed UE engine 208A may access data repository 204 and obtain UE data 206A of a UE 104A. As described herein, UE data of the UE 104, such as UE data 206A of UE 104A, may include data associated with a new process that executed UE engine 208A is to monitor, such as a new trained machine learning process, and data associated with another process, such as a legacy process, that executed UE engine 208A utilizes to determine the performance of the new process. The data associated with the new process and the other process, such as the legacy process, may include data identifying the new and other process and data identifying and characterizing parameters of each of the new process and the other process, such as model parameters in examples where one or both of the processes are trained machine learning process. Additionally, UE data of the UE 104, such as UE data 206A of UE 104A, may include data identifying the corresponding UE 104 (e.g., a corresponding serial number or an identifying number), such as UE 104A, and data indicating a performance status of the one or more processes. Examples of the performance status of the one or more processes includes a performance status that indicates the performance of a particular process is below a predetermined standard, and a performance status that indicates the performance of a particular trained machine learning process is above or at a predetermined standard. Additionally, executed UE engine 208A may generate parameter data 304 including one or more portions of UE data 206A of the UE 104A. For instance, parameter data 304 may include data identifying UE 104A. Further, executed UE engine 208A may generate parameter data 304 including data based on one or more portions of UE data of the UE 104. For instance, one or more parameters that UE engine 208A derived from UE data 206A.

In some instances, executed UE engine 208A may, for a particular UE 104, such as UE 104A, determine the one or more parameters based on the UE data (e.g., UE data 206A of UE 104A) of a new process that UE engine 208A is to monitor, and UE data of a (e.g., UE data 206A of UE 104A) of another process, such as a legacy process. In such instances, the second process may be utilized by UE engine 208A to determine the performance of the new process. For example, UE engine 208A may determine timing parameter 304A based on data of model parameters of the new process and the legacy process. In some instances, based on model parameters associated with measurement periods of the new process and legacy process, UE engine 208A may determine timing parameter 304A that causes UE 104, such as UE 104A, to configure the new process and legacy process to generate comparable measurement data. For instance, one or more elements of measurement data of the new process and the one or more elements of measurement data of the legacy process may have matching timestamps or timestamps that are within a predetermined time threshold or margin.

Additionally, UE engine 208A may generate reporting request 302 and may package one or more portions of parameter data 304 into portions of reporting request 302. Further, executed UE engine 208A may transmit reporting request 302 to UE 104A. Although, FIG. 3, illustrates a wireless communication system 100 that includes one LMF computing system 102, such as LMF computing system 102A, communicating with one UE 104, such as UE 104A, LMF computing system 102 may transmit a reporting request, such as reporting request 302, to any number of UE 104. Further, the reporting request may be specific to the process that the LMF computing system 102 is monitoring on the corresponding UE 104. LMF computing system 102 may initiate the monitoring of a particular process on a corresponding UE 104 by transmitting the reporting request to the corresponding UE 104.

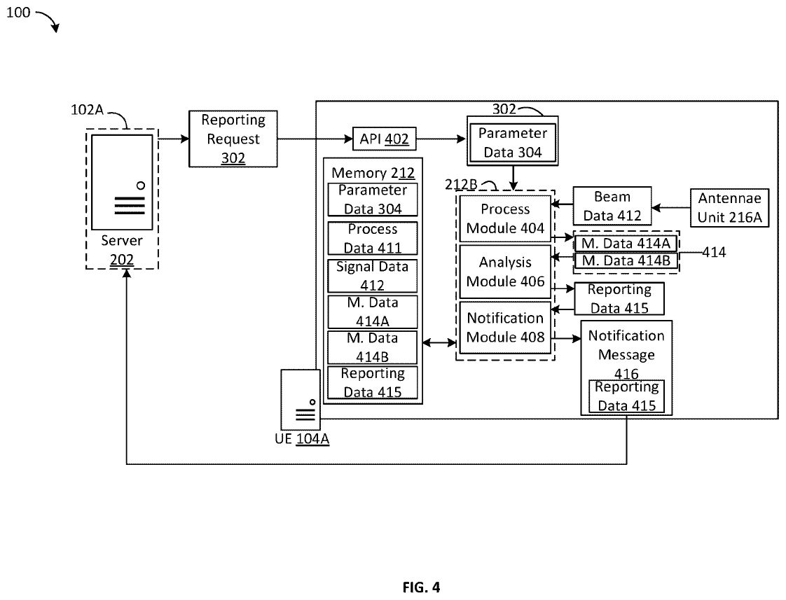

As described herein, LMF computing system 102, such as LMF computing system 102A, may monitor a performance of the new process identified in reporting request 302, based on first measurement data of the new process and second measurement data of the legacy process. The first measurement data and the second measurement data may be transmitted from a corresponding UE 104 to LMF computing system 102. Additionally, the corresponding UE 104, such as UE 104A, may generate the first measurement data by applying the new process to a detected one or more beams transmitted from BS 103, and the second measurement data by applying the legacy process to the detected one or more beams. Moreover, UE 104, such as UE 104A, may apply the new process and the legacy process to the detected one or more beams, in accordance with parameter data 304 of the reporting request. Further, UE 104, such as UE 104A, may generate reporting data associated with the first measurement data and the second measurement data. In various examples, the reporting data may indicate a performance of a process that is being monitored, such as the first process, based on the first measurement data and the second measurement data. FIG. 4, illustrates an example UE 104A that generates the reporting data 415. Although FIG. 4 may only illustrate UE 104A, any number of UE 104 may perform operations as described herein to generate reporting data, such as reporting data 415. Each UE 104 that receives a reporting request from LMF computing system 102, such as LMF computing system 102A, may each generate reporting data, such as reporting data 415, associated with the reporting request.

As illustrated in FIG. 4, a programmatic interface established and maintained by UE 104A, such as application programming interface (API) 402 of UE 104A, may receive reporting request 302 that includes parameter data 304. Parameter data 304 may include one or more parameters, such as timing parameter 304A, resource parameter 304B and model parameter 304C. As described herein, UE 104A may receive reporting request 302, across a communications network from LMF computing system 102A, such as executed UE engine 208A, via a channel of communications established programmatically between API 402 and executed UE engine 208A.

In various examples, one or more application programs 212B, executed by processor 214 of UE 104A, such as process module 404, analysis module 406, and notification module 408 of UE 104A, may perform any of the exemplary processes described herein, to generate reporting data 415 indicating a performance of the new process, such as a first new and trained machine learning process. Executed UE engine 208A of LMF computing system 102 may utilize reporting data 415 obtained from UE 104A to modify or change the configuration of UE 104A. By way of example, upon execution by processor 214 of UE 104A, executed process module 404 may perform operations that store parameter data 304 within memory 212. In such an example, parameter data 304 may include one or more parameters, such as timing parameter 304A, resource parameter 304B and model parameter 304C.

Additionally, executed process module 404 may perform operations that access memory 212 to obtain process data 411. Portions of process data 411 may be associated with one or more processes, such as the new process and the legacy process, UE 104A (or any UE 104) may implement. Each of the one or more processes that UE 104A may implement, may be associated with generating measurement data from one or more beams detected by antenna unit 216A and transmitted from BS 103. Moreover, executed process module 404 may perform operations that access memory 212 to obtain parameter data 304. Based on the model parameter 304C of the reporting request, process module 404 may identify a process LMF computing device 102A is monitoring, such as the new process, as well as an additional process to determine the performance of the process LMF computing device 102A is monitoring. In some examples, corresponding UE 104, such as UE 104A, may utilize measurement data of the additional process, such as the legacy process, in determining the performance of the process being monitored. In other examples, model parameter 304C may at least identify the process to be monitored, such as the new process, and may identify the additional process.

Further, executed process module 404 may, based on the identified process to be monitored and identified additional process, obtain portions of process data 411 associated with the process to be monitored, such as the new process, and portions of process data 411 associated with the additional process, such as the legacy process. In some instances, the process to be monitored, such as the new process, is a new and trained machine learning process. In such instances, the portions of process data 411 associated with the process to be monitored, such as the new process, may include one or more model parameters. Additionally, process module 404 may deploy the new process in accordance with the one or more model parameters included in the portions of associated process data 411. In other instances, portions of process data 411 associated with the legacy process include one or more parameters, such as model parameters in examples where the legacy process is a trained legacy machine learning process, that process module 404 may utilize to deploy the additional or legacy process.

Based on the obtained portions of process data 411 associated with the new process or process to be monitored, obtained portions of process data 411 associated with the additional process or legacy process, and the obtained parameter data 304, executed process module 404 may apply the new process and the legacy process to beam data 412 of one or more beams detected by from antenna unit 216A and transmitted from BS 103. In some examples, executed process module 404 may apply the new process to beam data 412 in accordance with the portions of process data 411 associated with the new process and the parameter data 304. In such examples, executed process module 404 may generate first measurement data 414A associated with the new process. The first measurement data 414A may include one or more measurements of the detected beam of beam data 412. Additionally, executed process module 404 may apply the legacy process to beam data 412 in accordance with the portions of process data 411 associated with the legacy process and the parameter data 304. Moreover, executed process module 404 may generate second measurement data 414B associated with the legacy process. The second measurement data 414B may include one or more measurements of the detected beam of beam data 412. In some instances, process module 404 may store first measurement data 414A and second measurement data 414B in memory 212.

As described herein, the parameter data 304 may cause measurement data generated by the process to be monitored and the additional process, such as first measurement data 414A and second measurement data 414B, to be comparable for the purpose of determining a performance of the process to be monitored. For instance, parameter data 304 may include timing parameter 304A that identifies a period of time or a measurement period a corresponding UE 104 makes measurements from the new process and the legacy process. In such an instance, following the example above, executed process module 404 may apply the new process to beam data 412 in accordance with the portions of process data 411 associated with the new process and for the identified period of time as indicated in the timing parameter 304A. Additionally, executed process module 404 may apply the legacy process to beam data 412 in accordance with the portions of process data 411 associated with the legacy process and for the identified period of time as indicated in the timing parameter 304A. That way, the generated first and second measurement data of the new and legacy process, respectively, may include one or more elements that may have timestamps or timestamps that are within a predetermined time threshold or margin. As described herein each element of the one or more elements may be associated with a measurement of the beam of beam data 412 determined by a corresponding process, such as the new process or legacy process.

In another instance, parameter data 304 may include resource parameter 304B that identifies one or more resources, attributes or data the corresponding process, such as the new or legacy process, may measure from beam data 412 of the one or more beams detected by antenna unit 216A and transmitted from BS 103. In such an instance, such resources, attributes, or data may be associated with assistance data, PFL ID(s), PRS resource ID, TRP, and PRS resource set ID. Additionally, following the example above, executed process module 404 may apply the new process to beam data 412 in accordance with the portions of process data 411 associated with the new process and for the identified resource as indicated in the resource parameter 304B. Moreover, executed process module 404 may apply the legacy process to beam data 412 in accordance with the portions of process data 411 associated with the legacy process and for the identified resource as indicated in the resource parameter 304B. That way, the generated first measurement data 414A and second measurement data 414B of the new and legacy process, respectively, may include one or more elements and each of the one or more elements may be associated with the same identified resource. As described herein, the one or more elements may be further associated with a measurement or measurement information of the beam of beam data 412 determined by a corresponding process, such as the new process or legacy process, and of the same identified resource. For instance, based on the identified resource indicated in the resource parameter 304B, each of the one or more elements of the first measurement data 414A and second measurement data 414B may include measurement information or characterize a measurement associated with RSRPP.

In some examples, resource parameter 304B may be associated with a particular positioning method (e.g., UE assisted or UE based). In such examples, first measurement data 414A and second measurement data 414B may be associated with the positioning method that resource parameter 304B is associated with. For example, reporting request 302 may include resource parameter 304B associated with DL-TDOA positioning method. Additionally, the corresponding UE 104 may implement the new process to generate first measurement data 414A and implement the legacy process to generate a second measurement data 414B. In such an example, first measurement data 414A and second measurement data 414B may each be associated with DL-TDOA positioning method. For instance, first measurement data 414A and second measurement data 414B may include data identifying RSTD, RSRP and/or RSRPP.

Referring back to FIG. 4, executed process module 404 may provide first measurement data 414A of beam data 412 and second measurement data 414B of beam data 412 as inputs to executed analysis module 406. Executed analysis module 406 may perform operations that compares first measurement data 414A and second measurement data 414B. For example, executed analysis module 406 may access memory 212 and obtain first measurement data 414A and second measurement data 414B. Additionally executed analysis module 406 may parse first measurement data 414A and obtain one or more elements of first measurement data 414A, and parse second measurement data 414B and obtain one or more elements of second measurement data 414B. As described herein each of the one or more elements of first measurement data 414A and second measurement data 414B may each be associated with a particular measurement made from a particular resource by a corresponding process, such as new process and legacy process respectively. Additionally, the measurements may have been made by the corresponding process (e.g., new process and legacy process) and on beam data 412 of one or more beams detected by antenna unit 216A and transmitted from BS 103. Further, each of the one or more elements of first measurement data 414A and second measurement data 414B may include a value of the associated measurement and each of first measurement data 414A and second measurement data 414B may be associated with a timestamp indicating a time the associated measurement was made by UE 104A and with the new process or legacy process.

Additionally, executed analysis module 406 may compare a value of each of one or more elements of first measurement data 414A with a value of each of one or more elements of second measurement data 414B. A value of an element of first measurement data 414A that is compared by executed analysis module 406 to a value of an element of second measurement data 414B may each be associated with a timestamp that matches or are within a predetermined time threshold or margin. Moreover, executed analysis module 406 may determine a difference between the values and may determine whether the determined difference exceeds a difference threshold. Executed analysis module 406 may determine the first process or new process associated with the first measurement data 414A is performing above or below a quality/standard threshold, based on executed analysis module 406 determining whether the determined difference exceeds a difference threshold.

In some examples, executed analysis module 406 may determine the determined difference exceeds a difference threshold. In such example, executed analysis module 406 may determine the first process, such as the new process, is performing below a quality/standard threshold. Additionally, executed analysis module 406 may generate reporting data 415 indicating that the monitored process or first process, such as the new process, is performing below the quality/standard threshold. Moreover, executed analysis module 406 may store reporting data 415 within memory 212. In some instances, upon execution by processor 214 of UE 104A, executed notification module 408, may generate notification message 416. Further, executed notification module may include within portions of notification message 416, one or more portions of reporting data 415 indicating that the monitored process or first process, such as the new process, is performing below the quality/standard threshold. In such instances, executed notification module 408 may transmit notification message 416 to LMF computing system 102A.

In other examples, executed analysis module 406 may determine the determined difference is below or at a difference threshold. In such examples, executed analysis module 406 may determine the first process, such as the new process, is performing above or at a quality/standard threshold. Additionally, executed analysis module 406 may generate reporting data 415 indicating that the monitored process or first process, such as the new process, is performing above or at a quality/standard threshold. Moreover, executed analysis module 406 may store reporting data 415 within memory 212. In some instances, upon execution by processor 214 of UE 104A, executed notification module 408, may generate notification message 416. Further, executed notification module may include within portions of notification message 416, one or more portions of reporting data 415 indicating that the monitored process or first process, such as the new process, is performing above or at the quality/standard threshold. In such instances, executed notification module 408 may transmit notification message 416 to LMF computing system 102A.

In various examples, executed analysis module 406 may generate reporting data 415 when executed analysis module 406 determines the determined difference exceeds a difference threshold. In such examples, executed analysis module 406 may not generate reporting data 415 when executed analysis module 406 determines the determined difference does not exceed a difference threshold. Alternatively, executed notification module 408 may generate notification message 416 for reporting data 415 indicating that the monitored process or first process, such as the new process, is performing below the quality/standard threshold. Additionally, executed notification module 408 may not generate notification message 416 for reporting data indicating that the monitored process or first process, such as the new process, is performing above or at quality/standard threshold.

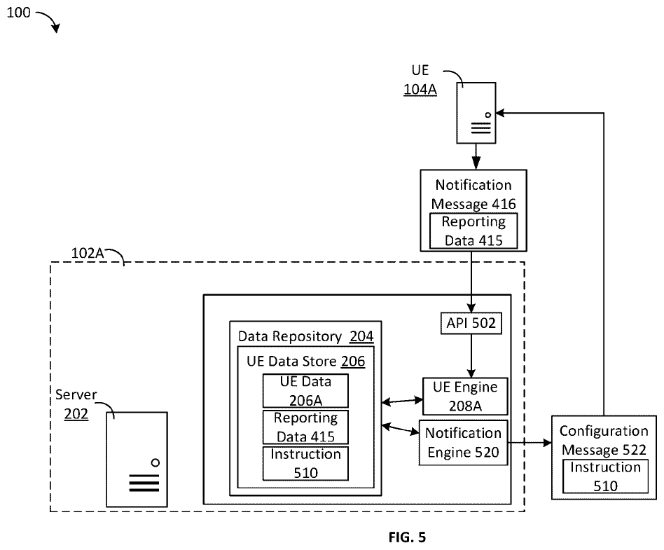

LMF computing system 102, such as LMF computing system 102A may receive, from one or more UA 104, a notification message including reporting data indicating a monitored process is performing below the quality/standard threshold (e.g., notification message 416 including reporting data 415 indicating that the monitored process or first process, such as the new process, is performing below the quality/standard threshold). Based on the reporting data, LMF computing system 102 may modify or change the configuration of the corresponding UE 104. As illustrated in FIG. 5, UE 104A, such as executed notification module 408, may transmit notification message 416 across a communications network, via a channel of communications established between executed notification module 408 and API 502. As described herein notification message 416 may include reporting data 415 indicating the monitored process or first process, such as the new process, is performing below the quality/standard threshold. API 502 of server 202 may receive notification message 416 and may route notification message 416 to executed UE engine 208A. Executed UE engine 208A may implement operations that parse notification message 416 and obtain one or more portions of reporting data 415. Further, executed UE engine 208A may store one or more portions of reporting data 415 into a corresponding portion of data repository 204, such as UE data store 206.

Additionally, executed UE engine 208A may perform operations that modify or change the configuration of the corresponding UE 104, such as UE 104A, based on the one or more portions of reporting data. Referring to FIG. 5, executed UE engine 208A may access data repository 204 and obtain one or more portions of reporting data 415. Based on the one or more portions of reporting data 415, UE engine 208A may generate instructions 510 associated with UE 104A (or any corresponding UE 104 of the obtained one or more portions of reporting data). Additionally, executed UE engine 208A may store instruction 510 within a corresponding portion of data repository 204, such as UE data store 206. In some instances, instructions 510 may cause UE 104A to modify or change the configuration of UE 104A (or any corresponding UE 104 of the reporting data). For example, the one or more portions of reporting data 415 may indicate that the performance of a first process, such as the new process, is below a quality/standard threshold (e.g., a difference between first measurement data 414A of the new process and second measurement data 414B exceeds a difference threshold). In such an example, UE engine 208A may generate instruction 510 that may cause UE 104A to switch to or operate in a default/safe mode. In some instances, while UE 104A is operating in the default, safe or third mode, UE 104A may be configured to implement or deploy the additional process, such as the legacy process, or another process that an operator of the wireless communication system 100 has designated as robust and reliable, such as a third trained legacy machine learning process. In such instances, UE 104A may apply the additional process or the other process to generate measurement data that LMF computing system 102 may utilize to provide location services for UE 104A.

As described herein, while UE 104A (or any other UE 104) is generating measurement data, such as measurement data 414, and reporting data, such as reporting data 415, UE 104A may be operating in a reporting mode. Additionally, UE 104A (or any other UE 104) may be configured to operate in a reporting mode upon receiving, from LMF computing system 102, such as LMF computing system 102A, a reporting request, such as reporting request 302. Moreover, upon UE 104A receiving or processing instruction 510, UE 104A may switch to the default/safe mode from the reporting mode.

Moreover, upon execution by one or more processors of server 202 of LMF computing system 102A, executed notification engine 520 may access data repository and obtain instruction 510. Moreover, executed notification engine 520 may generate configuration message 522 and may package one or more portions of instruction 510 into portions of configuration message 522. Further, executed notification engine 520 may transmit configuration message 522 to UE 104A over a communications network, via a channel of communications established between UE 104A and executed notification engine 520.

In some examples, LMF computing system 102, such as LMF computing system 102A may process measurement data of a process to be monitored and measurement data of another process, such as a legacy process to determine a performance of the monitored process. In some instances, reporting data 415 may include measurement data, such as first measurement data 414A, of a process to be monitored and such process may be a new and trained machine learning process. Additionally, the reporting data 415 may include measurement data of a legacy process, such as second measurement data 414B. Additionally, the measurement data of the new and trained machine learning process may include location estimates, while the measurement data of the legacy process may include raw data or measurements that LMF computing system 102, such as executed UE engine 208A. may utilize to generate corresponding location estimates. In such instances, LMF computing system 102 may compare the location estimates of the new and trained machine learning process to the location estimates determined from the legacy process to determine the accuracy and the performance of the new and trained machine learning process. Based on such determinations, LMF computing system 102 may generate an instruction, such as instruction 510, for the corresponding UE 104, such as UE 104A. As described herein, the instruction may cause the corresponding UE 104 to operate in a different mode and implement a process associated with the different mode to generate measurement data. The measurement data may then be utilized by LMF computing system 102 to provide location services to the corresponding UE.

For instance, LMF computing system 102 may determine a difference between a value associated with the location estimate of the new and trained machine learning process to a value associated with the location estimate determined from the legacy process. Additionally, LMF computing system 102 may determine whether the determined difference exceeds a difference threshold. In examples where the determined difference exceeds the difference threshold, LMF computing system 102 may generate an instruction that causes the corresponding UE 104 to operate in the default/safe mode as described herein.

In other examples, LMF computing system 102, such as LMF computing system 102A may update, for a particular UE 104, a status of a process being implemented on the corresponding UE 104. In such examples, the process may be process being monitored by the corresponding LMF computing system 102. Additionally, the process may be a new process, such as a new and trained machine learning process. For example, referring to FIG. 5, LMF computing system 102A may receive, from UE 104A, notification message 416 including reporting data 415 indicating a new process being monitored is performing above or at a quality/standard threshold. In such an example, UE engine 208A may access UE data 206A of UE 104A and update data related to the status of the new process based on reporting data 415 (e.g., currently or at the time UE 104A determined the new process is performing above or at the quality/standard threshold, the new process is performing above or at the quality/standard threshold). In another example, LMF computing system 102A may receive, from UE 104A, notification message 416 including reporting data 415 indicating a new process being monitored is performing below a quality/standard threshold. In such an example, UE engine 208A may access UE data 206A of UE 104A and update data related to the status of the new process based on reporting data 415 (e.g., currently or at the time UE 104A determined the new process is performing below the quality/standard threshold, the new process is performing below the quality/standard threshold).

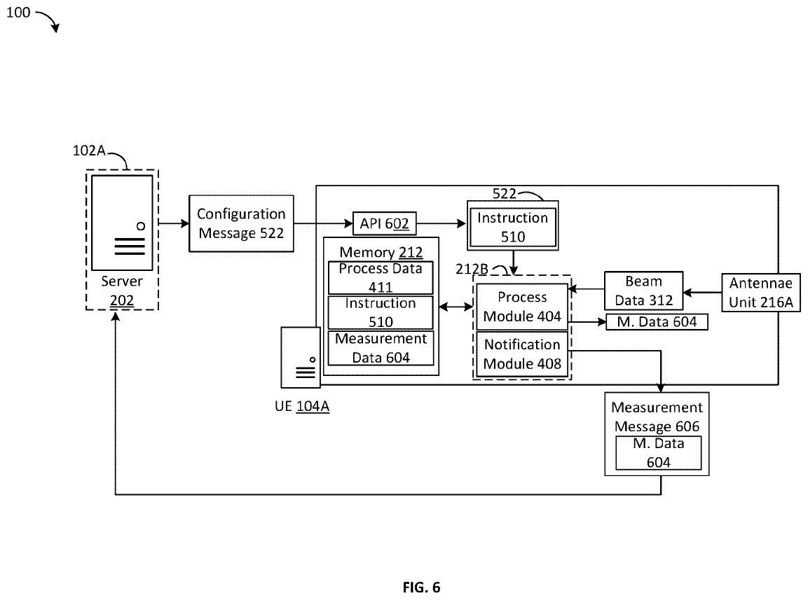

Referring to FIG. 6, API 602 of UE 104A may receive configuration message 522 from UE 104A, such as executed notification engine 520 of FIG. 5. API 602 may route configuration message 522 to executed process module 404. Additionally, executed process module 404 may parse configuration message 522 and obtain one or more portions of instruction 510. Further, executed process module 404 may store one or more portions of instruction 510 into a memory 212.

In some examples, executed process module 404 may configure UE 104A in accordance with instruction 510. In such examples, executed process module 404 may implement operations that access memory 212 to obtain instruction 510. As described herein, instruction 510 may include programmatic instructions for UE 104A to switch to or operate in a default/safe mode. Additionally, instruction 510 may identify a particular process associated with the default/safe mode. Moreover, while UE 104A is operating in the default mode, UE 104A may utilize the process associated with the default/safe mode to generate measurement data. In some instances, the particular process identified in instruction 510 may be a process utilized to determine the performance of the legacy process, such as the legacy process, or another process that an operator of the wireless communication system 100 has designated as robust and reliable, such as a third trained legacy machine learning process.

In various instances, UE 104A may automatically fall back and operate in the default/safe mode in response to UE 104A determining the performance of the process to be monitored or new process is below a quality or standard threshold. As described herein, UE 104A (or any UE 104) maybe operating in another mode, such as a second or reporting mode, when UE 104A determines whether the performance of the process to be monitored or new process is below a quality or standard threshold. As such, UE 104A (or any UE 104) may, without receiving instruction 510 from LMF computing system 102A (or any LMF computing system 102), automatically switch to the default/safe mode upon determining the performance of the process to be monitored or new process is below a quality or standard threshold.

Further, while UE 104A is operating in the default/safe mode and based on instruction 510, executed process module 404 may implement the process identified in instruction 510 to generate measurement data 604. For example, based on instruction 510, executed process module 404 may identify a particular process, such as the legacy process or the other process. Additionally, executed process module 404 may access memory 212 to obtain portions of process data 411 that are associated with the identified particular process. As described herein the portions of process data 411 that are associated with the identified particular process may include one or more parameters that enable executed process module 404 to configure and deploy the identified particular process. For instance, the particular process may be a trained legacy machine learning process and the obtained portions of process data 411 may include one or more model parameters of the trained legacy machine learning process. As such, executed process module 404 may configure and deploy the trained legacy machine learning process in accordance with the one or more model parameters. Moreover, executed process module 404 may apply the identified particular process to beam data 312 of one or more beams detected by antenna unit 216A and transmitted by BS 103. Further, executed process module 404 may generate measurement data 604 based on the application of the identified particular process to the beam data 312. In some instances, executed process module 404 may store measurement data 604 in memory 212.

As described herein, LMF computing system 102A (or any LMF computing system 102) may utilize measurement data, such as measurement data 604 to provide location services for UE 104A. For example, referring to FIG. 6, executed notification module 408 may access memory 212 to obtain measurement data 604. Additionally, executed notification module 408 may generate measurement message 606 and package one or more portions of measurement data 604 into portions of measurement message 606. Further, executed notification module 408 may transmit to LMF computing system 102A measurement message 606. LMF computing system 102A, such as executed UE engine 208A may parse measurement message 606; obtain the one or more portions of measurement data 604 from the parsed measurement message 606; and implement operations that provide location services to UE 104A based on the obtained one or more portions of measurement data 604 (not illustrated in FIG. 6).

In some examples, UE 104A may be configured to operate in one or more modes, such a first or normal mode, a second or reporting mode, and third or default/safe mode. Each mode may be associated with deployment of one or more processes, such as the new process and legacy process. In some instances, prior to receiving reporting request 302, UE 104A (or any UE 104) may be configured to operate in a first or normal mode. While UE 104A is operating in the first or normal mode, UE 104A may apply a first process, such as the new process, to one or more detected beams transmitted from BS 103, in accordance with the one or more parameters of the first process included in the obtained corresponding portions of process data 411. Additionally, UE 104A may determine one or more measurements and generate measurement data, such as first measurement data 414A, including the one or more measurements based on the application of the first process to the one or more detected beams (e.g., beam data 412). Moreover, UE 104A may communicate the measurement data, such as first measurement data 414A, to LMF computing system 102A. LMF computing system 102A may provide locations services to UE 104A based on the measurement data.

In other instances, in response to receiving reporting request 302, UE 104A (or any UE 104) may be configured to operate in a second or reporting mode. While UE 104A is operating in the second or reporting mode, UE 104A may apply a first process, such as the new process, and a second process, such as the legacy process, to one or more detected beams transmitted from BS 103, in accordance with the one or more parameters of the first and second process included in the obtained corresponding portions of process data 411 and the parameter data, such as parameter data 304 included in the reporting request 302. As described herein, UE 104A may determine one or more measurements and generate measurement data, such as first measurement data 414A, including the one or more measurements based on the application of the first process to the one or more detected beams (e.g., beam data 412). Additionally, UE 104A may determine one or more measurements and generate measurement data, such as second measurement data 414B, including the one or more measurements based on the application of the second process to the one or more detected beams (e.g., beam data 412). Further, UE 104A may communicate an indication of a performance of the first process based on the measurement data of the first and second process to LMF computing system 102A. LMF computing system 102A may modify or change the configuration of UE 104A based on the indication. As described herein, if UE 104A is operating in another mode, such as a first or normal mode, UE 104A may switch to the reporting mode upon receiving the reporting request 302. In some instance, while UE 104A is operating in the reporting mode, UE 104A may deploy the first process, such as the new process (e.g., new and trained machine learning process) and second process, such as the legacy process, simultaneously or concurrently.

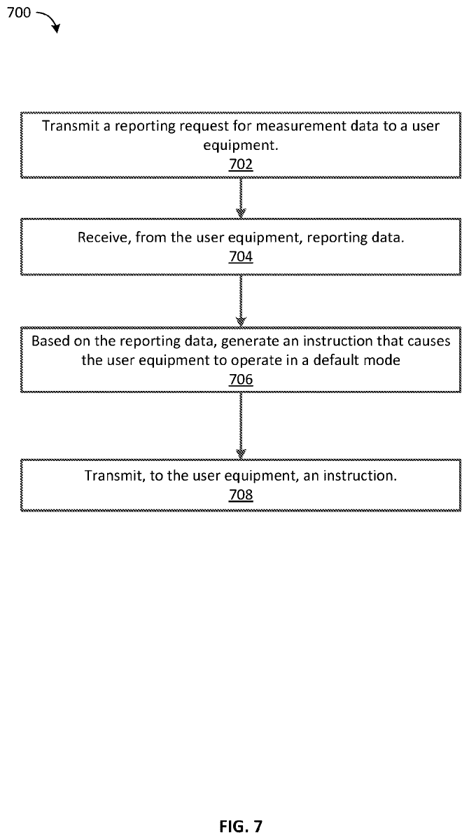

FIG. 7 is a flowchart of an exemplary process 700 for determining a performance of a process, such as a new process, deployed by user equipment (UE) 104. For example, one or more LMF computing systems 102, such as LMF computing system 102A, may perform one or more of the steps of exemplary process 700, as described below in reference to FIG. 7. Referring to FIG. 7, LMF computing system 102A may perform any of the processes described herein to transmit reporting request 302 to UE 104A (e.g., in step 702 of FIG. 7). As described herein, reporting request 302 may include parameter data 304. In some instances, parameter data 304 may include one or more monitoring parameters, such as timing parameter 304A, resource parameter 304B and modelling or processing parameter 304C. Additionally, executed UE engine 208A may utilize UE data 206A of UE 104A to determine one or more monitoring parameters included in parameter data 304. Additionally, as described herein, UE data 206A of UE 104A, may include data associated with a new process that executed UE engine 208A is to monitor, such as a new trained machine learning process, and data associated with another process, such as a legacy process, that executed UE engine 208A utilizes to determine the performance of the new process. The data associated with the new process and the other process, such as the legacy process, may include data identifying the new and other process and data identifying and characterizing parameters of each of the new process and the other process, such as model parameters in examples where one or both of the processes are trained machine learning process. Additionally, UE data 206A of UE 104A may include data identifying the UE 104A (e.g., a corresponding serial number or an identifying number), and data indicating a performance status of the one or more processes. Examples of the performance status of the one or more processes includes, a performance status that indicates the performance of a particular process is below a predetermined standard, and a performance status that indicates the performance of a particular trained machine learning process is below a predetermined standard.

For instance, executed UE engine 208A may access data repository 204 and obtain UE data 206A of a UE 104A. Additionally, executed UE engine 208A may generate parameter data 304 including one or more portions of UE data 206A of the UE 104A. For instance, parameter data 304 may include data identifying UE 104A. Further, executed UE engine 208A may generate parameter data 304 including data based on one or more portions of UE data of the UE 104. For instance, one or more parameters that UE engine 208A derived from UE data 206A, such as timing parameter 304A. Additionally, executed UE engine 208A may generate reporting request 302 and package within portions of reporting request 302, one or more portions of parameter data 304. Further, executed UE engine 208A may transmit reporting request 302 to API 402 of UE 104A.

In response to receiving reporting request 302, UE 104A may operate in a reporting mode and executed process module 404 may implement operations as described herein to generate measurement data, such as first measurement data 414A and second measurement data 414B, in accordance with reporting request 302. Additionally, while UE 104A is operating in a reporting mode, executed process module 404 may determine a performance of a first process identified in reporting request 302, such as a new and trained machine learning process, based on the measurement data. Based on the determined performance, executed process module 404 may generate reporting data 415 that may indicate the performance of the first process. In some instances, reporting data 415 may indicate a comparison between measurement data generated by the first process, such as first measurement data 414A, and measurement data of a second process utilized to determine the performance of the first process. In such instances, the comparison may indicate the performance of the first process. Further, executed process module 404 may transmit, to LMF computing system 102A, such as API 502, reporting data 415.

Referring back to FIG. 7, LMF computing system 102A may perform any of the processes described herein to receive, from UE 104A, the reporting data 415 (e.g., in step 704 of FIG. 7). Additionally, based on reporting data 415, LMF computing system 102A may generate an instruction that causes the user equipment to implement at least one of the first process and the second process (e.g., in step 706 of FIG. 7). For example, UE 104A, such as executed notification module 408, may transmit notification message 416 across a communications network, via a channel of communications established between executed notification module 408 and API 502. As described herein notification message 416 may include reporting data 415 indicating the performance of the monitored process or first process, such as the new process. API 502 of server 202 may receive notification message 416 and may route notification message 416 to executed UE engine 208A. Executed UE engine 208A may implement operations that parse notification message 416 and obtain one or more portions of reporting data 415. Additionally, executed UE engine 208A may generate instruction 510 based on the one or more portions of reporting data 415.

In some instances, reporting data 415 may indicate the first process is performing below the quality/standard threshold. Based on reporting data 415, executed UE engine 208A may generate instructions 510 associated with UE 104A. Instructions 510 may cause UE 104A to modify or change the configuration of UE 104A (or any corresponding UE 104 of the reporting data). For instance, instruction 510 may cause UE 104A to switch from a reporting mode to a default/safe mode. In such an instance, while UE 104A is operating in the default, safe or third mode, UE 104A may be configured to implement or deploy the additional process, such as the legacy process, or another process that an operator of the wireless communication system 100 has designated as robust and reliable, such as a third trained legacy machine learning process.

In other instances, reporting data 415 may indicate the first process is performing above or at the quality/standard threshold. Based on reporting data 415, executed UE engine 208A may generate instructions 510 associated with UE 104A. Instructions 510 may cause UE 104A to modify or change the configuration of UE 104A (or any corresponding UE 104 of the reporting data). For instance, instruction 510 may cause UE 104A to switch from a reporting mode to a first or normal mode. In such an instance, while UE 104A is operating in the normal or first mode, UE 104A may be configured to implement or deploy the first process, such as a new and trained legacy machine learning process.

Additionally, LMF computing system 102A may transmit, to UE 104A, instruction 510 (e.g., step 710 of FIG. 7). As described herein, upon execution by one or more processors of server 202 of LMF computing system 102A, executed notification engine 520 may generate configuration message 522 and may package one or more portions of instruction 510 into portions of configuration message 522. Further, executed notification engine 520 may transmit configuration message 522 to UE 104A over a communications network, via a channel of communications established between UE 104A and executed notification engine 520. Additionally, API 602 of UE 104A may receive configuration message 522 from UE 104A, such as executed notification engine 520 of FIG. 5. API 602 may route configuration message 522 to executed process module 404. Additionally, executed process module 404 may parse configuration message 522 and obtain one or more portions of instruction 510.

In instances where instruction 510 is associated with reporting data 415 indicating the first process is performing below the quality/standard threshold, executed process module 404 may cause UE 104A to switch from operating in a reporting mode to a default/safe mode. As described herein, the default/safe mode may be associated with a particular process that UE 104A may utilize to measurement data, such as the legacy process or another process that an operator of the wireless communication system 100 has designated as robust and reliable, such as a third trained legacy machine learning process. Additionally, while UE 104A is operating in the default/safe mode, UE 104A may implement operations as described herein to generate measurement data, such as measurement data 604, that LMF computing system 102A may utilize to provide location services for UE 104A.

For instance, executed process module 404 may identify a particular process associated with the default/safe mode, based on the one or more portions of instruction 510. Additionally, executed process module 404 may access memory 212 to obtain portions of process data 411 that are associated with the identified particular process. As described herein the portions of process data 411 that are associated with the identified process may include one or more parameters that enable executed process module 404 to configure and deploy the identified particular process. For example, the particular process may be a trained legacy machine learning process and the obtained portions of process data 411 may include one or more model parameters of the trained legacy machine learning process. As such, executed process module 404 may configure and deploy the trained legacy machine learning process in accordance with the one or more model parameters. Moreover, executed process module 404 may apply the identified particular process to beam data 312 of one or more beams detected by antenna unit 216A and transmitted by BS 103. Further, executed process module 404 may generate measurement data 604 based on the application of the identified particular process to the beam data 312.

As described herein, LMF computing system 102A may obtain and utilize measurement data, such as measurement data 604 to provide location services for UE 104A. For example, executed notification module 408 may access memory 212 to obtain measurement data 604. Additionally, executed notification module 408 may generate measurement message 606 and package one or more portions of measurement data 604 into portions of measurement message 606. Further, executed notification module 408 may transmit to LMF computing system 102A measurement message 606. LMF computing system 102A, such as executed UE engine 208A may parse measurement message 606; obtain the one or more portions of measurement data 604 from the parsed measurement message 606; and implement operations that provide location services to UE 104A based on the obtained one or more portions of measurement data 604 (not illustrated in FIG. 6).

In instances where instruction 510 is associated with reporting data 415 indicating the first process is performing above the quality/standard threshold, executed process module 404 may cause UE 104A to switch from operating in a reporting mode to a first or normal mode. As described herein, the first/normal mode may be associated with a particular process that UE 104A may utilize to measurement data, such as the first process. In some instances, the first process may be a new and trained machine learning process. Additionally, while UE 104A is operating in the first/normal mode, UE 104A may implement operations as described herein to generate measurement data, such as first measurement data 414A, that LMF computing system 102A may utilize to provide location services for UE 104A.

For instance, executed process module 404 may determine the first process is associated with the first/normal mode, based on the one or more portions of instruction 510. Additionally, executed process module 404 may access memory 212 to obtain portions of process data 411 that are associated with the first process. As described herein the portions of process data 411 that are associated with the first process may include one or more parameters that enable executed process module 404 to configure and deploy the first process. For example, the first process may be a new and trained legacy machine learning process and the obtained portions of process data 411 may include one or more model parameters of the new and trained legacy machine learning process. As such, executed process module 404 may configure and deploy the new and trained machine learning process in accordance with the one or more model parameters. Moreover, executed process module 404 may apply the identified first process to beam data 312 of one or more beams detected by antenna unit 216A and transmitted by BS 103. Further, executed process module 404 may generate first measurement data 414A based on the application of the first process to the beam data 312. In some instances, executed process module 404 may store measurement data 414A generated while UE 104A is operating in the first mode, into memory 212.

As described herein, LMF computing system 102A may obtain and utilize measurement data, such as first measurement data 414A to provide location services for UE 104A. For example, executed notification module 408 may access memory 212 to obtain measurement data of the first process that was generated while UE 104A was operating in a first mode, such as measurement data 414A. Additionally, executed notification module 408 may generate a measurement message, such as measurement message 606, and package one or more portions of the obtained measurement data into portions of the measurement message. Further, executed notification module 408 may transmit to LMF computing system 102A the measurement message. LMF computing system 102A, such as executed UE engine 208A, may parse the measurement message; obtain the one or more portions of the measurement data from the parsed measurement message 606; and implement operations that provide location services to UE 104A based on the obtained one or more portions of the measurement data.

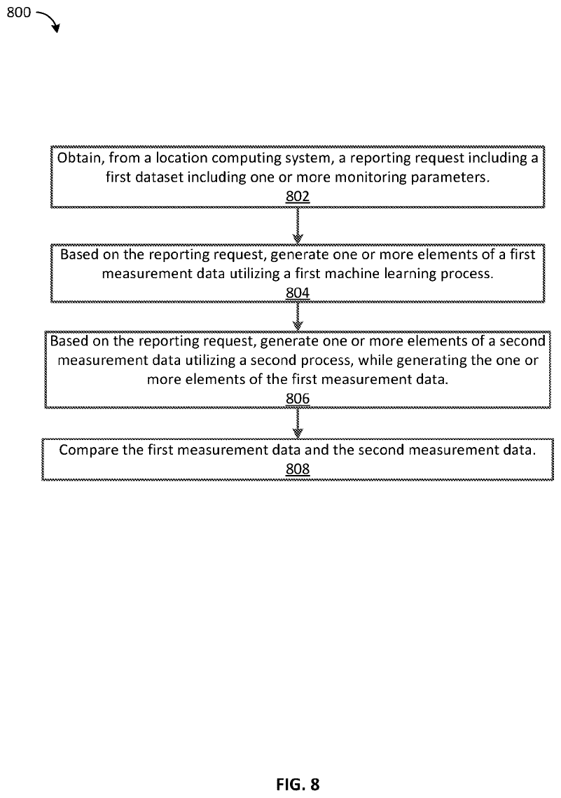

FIG. 8 is a flowchart of an exemplary process 800 for generating reporting data, in accordance with some exemplary embodiments. For example, one or more UE 104, such as UE 104A, may perform one or more of the steps of exemplary process 800, as described below in reference to FIG. 8. Referring to FIG. 8, a first UE 104A of a plurality of UE 104 (or any UE 104), may perform any of the processes described herein to obtain, from LMF computing system 102, a reporting request 302 including a first dataset including one or more monitoring parameters (e.g., in step 802 of FIG. 8). As described herein, reporting request 302 may include parameter data 304. In some instances, parameter data 304 may include one or more monitoring parameters, such as timing parameter 304A, resource parameter 304B and modelling or processing parameter 304C.

Based on reporting request 302, UE 104A may generate one or more elements of first measurement data 414A utilize a first trained machine learning process identified in reporting request 302 (e.g., step 804 of FIG. 8). As described herein, the first trained machine learning process may be a new process identified in reporting request 302, such as from modelling or processing parameter 304C of reporting request 302. Additionally, executed process module 404 may identify the first trained machine learning process from reporting request 302 and access memory 212 to obtain portions of process data 411 associated with the first trained machine learning process. In some instances, the portions of process data 411 associated with the first trained machine learning process may include one or more modeling parameters. Based on the obtained portions of process data 411 associated with the first trained machine learning process, and parameter data 304 of reporting request 302, executed process module 404 may apply the first trained machine learning process to beam data 412 of one or more beams detected by from antenna unit 216A and transmitted from BS 103. Further, executed process module 404 may generate first measurement data 414A based on the application of the first trained machine learning process to the beam data 412.

Additionally, based on reporting request 302, UE 104A may generate one or more elements of second measurement data 414B utilize a second process, while UE 104A generates the one or more elements of first measurement data 414A (e.g., step 806 of FIG. 8). As described herein, the second process may be a legacy process and/or a trained machine learning process. Additionally, the second process may be utilized to determine a performance of the first trained machine learning process. In some instances, reporting request 302 may identify the second process. In such instances, executed processing module 404 may identify the second process from reporting request 302 and access memory 212 to obtain portions of process data 411 associated with the second process. In some instances, the portions of process data 411 associated with the second process may include one or more parameters that executed processing module 404 may utilize to deploy the second process. Based on the obtained portions of process data 411 associated with the second process, and parameter data 304 of reporting request 302, executed process module 404 may apply the second process to the beam data 412. Further, executed process module 404 may generate second measurement data 414B based on the application of the second process to the beam data 412.

Moreover, UE 104A may compare the first measurement data 414A and the second measurement data 414B (e.g., step 808 of FIG. 8). As described herein, UE 104A may determine a performance of the first trained machine learning process, based on the comparison. For example, executed analysis module 406 may perform operations that compares first measurement data 414A and second measurement data 414B. For instance, executed analysis module 406 may parse first measurement data 414A and obtain one or more elements of first measurement data 414A, and parse second measurement data 414B and obtain one or more elements of second measurement data 414B. Each of the one or more elements of first measurement data 414A and second measurement data 414B may include a value of the associated measurement and each of first measurement data 414A and second measurement data 414B may be associated with a timestamp indicating a time the associated measurement was made by UE 104A and with the first trained machine learning process and second process, respectively. Additionally, executed analysis module 406 may compare a value of an element of first measurement data 414A with a value of an element of second measurement data 414B that are each associated with a timestamp that matches or are within a predetermined time threshold or margin. Moreover, executed analysis module 406 may determine a difference between the values and may determine whether the determined difference exceeds a difference threshold. Further, executed analysis module 406 may determine the first trained machine learning process associated with the first measurement data 414A is performing above or below a quality/standard threshold, based on executed analysis module 406 determining whether the determined difference exceeds a difference threshold. For instance, executed analysis module 406 determines the determined difference is at or below a difference threshold. In such an instance, executed analysis module 406 may determine the first trained machine learning process is performing above or at a quality/standard threshold. In another instance, executed analysis module 406 determines the determined difference exceeds a difference threshold. In such an instance, executed analysis module 406 may determine the first trained machine learning process is performing below a quality/standard threshold.

Implementation examples are further described in the following numbered clauses:
1. An apparatus, comprising:
   a non-transitory machine-readable storage medium storing instructions; and at least one processor coupled to the non-transitory machine-readable storage medium, the at least one processor being configured to execute the instructions to:
      transmit a reporting request for positioning data to a user equipment, wherein receipt of the reporting request by the user equipment causing the user equipment to perform operations in a first mode, the operations comprising:
         implementing a first process to generate first positioning data, and implementing a second process to generate second positioning data; and
         generating reporting data indicative of a comparison between the first
      positioning data and the second positioning data;
      receive, from the user equipment, the reporting data; and
      based on the reporting data, generate and transmit, to the user equipment, an instruction, wherein the instruction causes the user equipment to implement at least one of the first process or the second process.
2. The apparatus of clause 1, wherein the reporting request includes a timing parameter, the timing parameter identifies a time interval for the user equipment to operate in the first mode.
3. The apparatus of any of clauses 1-2, wherein the reporting request includes a resource parameter that identifies one or more resources for the user equipment to generate the positioning data from.
4. The apparatus of clause 3, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.
5. The apparatus of any of clauses 1-4, wherein the first positioning data is associated with a first subset of resources and the second positioning data is associated with a second subset of resources.
6. The apparatus of clause 5, wherein the second subset of resources includes the first subset of resources.
7. The apparatus of any of clauses 1-6, wherein the first positioning data and the second positioning data each include one or more elements associated with a same resource.
8. The apparatus of any of clauses 1-7, wherein the reporting request causes the user equipment to:
   generate a first timestamp associated with a first element of the one or more elements of the first positioning data and a second timestamp associated a second element of the one or more elements of the second positioning data, wherein the first element corresponds to the second element;
   compare the first timestamp with the second timestamp;
   determine the first timestamp and the second timestamp are within a predetermined temporal interval; and
   generate the reporting data based on the determination.
9. The apparatus of clause 8, wherein the reporting request further causes the user equipment to:
   determine the first timestamp and the second timestamp match.
10. The apparatus of any of clauses 1-9, wherein the reporting request further causes the user equipment to:
   simultaneously generate one or more elements of the first positioning data utilizing the first process and one or more elements of the second positioning data utilizing the second process.
11. the Apparatus of Clause 10, Wherein the Reporting Request Further Causes the User equipment to:
   compare the first positioning data and the second positioning data;
   based on the comparison, determine that a difference between a first element of the first positioning data and a corresponding first element of the second positioning data satisfies a difference threshold; and
   transmit, to the apparatus, the reporting data based on the determined difference satisfying the difference threshold.
12. The apparatus of clause 11, wherein prior to receiving the reporting request from the apparatus, the user equipment operates in a second mode and implements the first process to generate the first positioning data, and wherein the receipt of the reporting request by the user equipment causes the user equipment to:
   switch from operating in the second mode to the first mode;
   determine that at least the first element of the first positioning data and the corresponding first element of the second positioning data are within a predetermined time margin;
   compare at least the first element of the first positioning data and the corresponding first element of the second positioning data; and
   for a condition where the comparison is greater than a predetermined threshold, switch to operating in a third mode to generate additional positioning data.
13. The apparatus of clause 12, wherein, while the user equipment is operating in the third mode, the user equipment implements the second process to generate the additional positioning data.
14. The apparatus of clause 12, wherein, while the user equipment is operating in the third mode, the user equipment implements a third process to generate the additional positioning data.
15. The apparatus of any of clauses 1-14, wherein the first process is a trained machine learning process.
16. The apparatus of any of clauses 1-15, wherein the second process is a trained machine learning process.
17. The apparatus of any of clauses 1-16, wherein the reporting request includes a model parameter, wherein the model parameter identifies one or more processes to monitor, the one or more processes including the first process and the second process.
18. A non-transitory, machine-readable storage medium storing instructions that, when executed by at least one processor of a location server, causes the at least one processor to perform operations that include:
   transmitting a reporting request for positioning data to a user equipment, wherein receipt of the reporting request by the user equipment causes the user equipment to perform operations in a first mode, the operations comprising:
      implementing a first process to generate first positioning data, and implementing a second process to generate second positioning data; and
      generating reporting data indicative of a comparison between the first positioning data and the second positioning data; and
   receiving, from the user equipment, the reporting data; and
   based on the reporting data, generate and transmit, to the user equipment, an instruction, wherein the instruction causes the user equipment to implement at least one of the first process and or second process.
19. The non-transitory machine-readable storage medium of clause 18, wherein the reporting request includes a timing parameter, the timing parameter identifies a time interval for the user equipment to operate in the first mode.
20. The non-transitory machine-readable storage medium of clauses 18-19, wherein the reporting request includes a resource parameter that identifies one or more resources for the user equipment to generate the positioning data from.
21. The non-transitory, machine-readable storage medium of clause 20, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.
22. The non-transitory, machine-readable storage medium of any of clauses 18-22, wherein the first positioning data is associated with a first subset of resources and the second positioning data is associated with a second subset of resources.
23. The non-transitory, machine-readable storage medium of clause 22, wherein the second subset of resources includes the first subset of resources.
24. The non-transitory, machine-readable storage medium of any of clauses 18-23, wherein the first positioning data and the second positioning data each include one or more elements associated with a same resource.
25. The non-transitory, machine-readable storage medium of any of clauses 18-24, wherein the reporting request causes the user equipment to:
   generate a first timestamp associated with a first element of the one or more elements of the first positioning data and a second timestamp associated a second element of the one or more elements of the second positioning data, wherein the first element corresponds to the second element;
   compare the first timestamp with the second timestamp;
   determine the first timestamp and the second timestamp are within a predetermined temporal interval; and
   generate the reporting data based on the determination.
26. The non-transitory, machine-readable storage medium of clause 25, wherein the reporting request further causes the user equipment to:
   determine the first timestamp and the second timestamp match.
27. The non-transitory, machine-readable storage medium of any of clauses 18-26, wherein the reporting request further causes the user equipment to:
   simultaneously generate one or more elements of the first positioning data utilizing the first process and one or more elements of the second positioning data utilizing the second process.
28. The non-transitory, machine-readable storage medium of clause 27, wherein the reporting request further causes the user equipment to:
   compare the first positioning data and the second positioning data;
   based on the comparison, determine that a difference between a first element of the first positioning data and a corresponding first element of the second positioning data satisfies a difference threshold; and
   transmit, to the apparatus, the reporting data based on the determined difference satisfying the difference threshold.
29. The non-transitory, machine-readable storage medium of clause 28, wherein prior to receiving the reporting request from the apparatus, the user equipment operates in a second mode and implements the first process to generate the first positioning data, and wherein the receipt of the reporting request by the user equipment causes the user equipment to:
   switch from operating in the second mode to the first mode;
   determine that at least the first element of the first positioning data and the corresponding first element of the second positioning data are within a predetermined time margin;
   compare at least the first element of the first positioning data and the corresponding first element of the second positioning data; and
   for a condition where the comparison is greater than a predetermined threshold, switch to operating in a third mode to generate additional positioning data.
30. The non-transitory, machine-readable storage medium of clause 29, wherein, while the user equipment is operating in the third mode, the user equipment implements the second process to generate the additional positioning data.
31. The non-transitory, machine-readable storage medium of clause 29, wherein, while the user equipment is operating in the third mode, the user equipment implements a third process to generate the additional positioning data.
32. The non-transitory, machine-readable storage medium of any of clauses 18-31, wherein the first process is a trained machine learning process.
33. The non-transitory, machine-readable storage medium of any of clauses 18-32, wherein the second process is a trained machine learning process.
34. The non-transitory, machine-readable storage medium of any of clauses 18-33, wherein the reporting request includes a model parameter, wherein the model parameter identifies one or more processes to monitor, the one or more processes including the first process and the second process.
35. A computer-implemented method, comprising:
   transmitting, by a processor of a location server, a reporting request for positioning data to a user equipment, wherein receipt of the reporting request by the user equipment causes the user equipment to perform operations in a first mode, the operations comprising:
      implementing a first process to generate first positioning data and implementing a second process to generate second positioning data; and
      generating reporting data indicative of a comparison between the first positioning data and the second positioning data; and
   receiving, by the processor from the user equipment, the reporting data; and
   based on the reporting data, generate and transmit, to the user equipment, an instruction, wherein the instruction causes the user equipment to implement at least one of the first process and the second process.
36. The computer-implemented method of clause 35, wherein the reporting request includes a timing parameter, wherein the timing parameter identifies a time interval for the user equipment to operate in the first mode.
37. The computer-implemented method of any of clauses 35-36, wherein the reporting request includes a resource parameter that identifies one or more resources for the user equipment to generate positioning data from.
38. The computer-implemented method of clause 37, wherein the one or more resources includes a resource selected from a group comprising: resources associated with an assistance, resources associated with a positioning frequency layer (PFL), resources associated with a transmission reception (TRP) ID, resources associated with a positioning reference signal (PRS) resources, or combinations thereof.
39. The computer-implemented method of any of clauses 35-38, wherein the first positioning data is associated with a first subset of resources and the second positioning data is associated with a second subset of resources.
40. The computer-implemented method of clause 39, wherein the second subset of resources includes the first subset of resources.
41. The computer-implemented method of any of clauses 35-40, wherein the reporting request causes the user equipment to:
   generate a first timestamp associated with a first element of the one or more elements of the first positioning data and a second timestamp associated a second element of the one or more elements of the second positioning data, wherein the first element corresponds to the second element;
   compare the first timestamp with the second timestamp;
   determine the first timestamp and the second timestamp are within a predetermined temporal interval; and
42. The computer-implemented method of clause 41, wherein the reporting request further causes the user equipment to determine the first timestamp and the second timestamp match.
43. The computer-implemented method of any of clauses 35-42, wherein the reporting request further causes the user equipment to simultaneously generate one or more elements of the first positioning data utilizing the first process and one or more elements of the second positioning data utilizing the second process.
44. The computer-implemented method of clause 43, wherein the reporting request further causes the user equipment to:
   compare the first positioning data and the second positioning data;
   based on the comparison, determine that a difference between a first element of the first positioning data and a corresponding first element of the second positioning data satisfies a difference threshold; and
   transmit, to the processor of the location server, the reporting data based on the determined difference satisfying the difference threshold.
45. The computer-implemented method of clause 44, wherein prior to receiving the reporting request from the processor of the location server, the user equipment operates in a second mode, and wherein the receipt of the reporting request by the user equipment causes the user equipment to:
   switch from operating in the second mode to the first mode;
   determine that at least the first element of the first positioning data and the corresponding first element of the second positioning data are within a predetermined time margin;
   compare at least the first element of the first positioning data and the corresponding first element of the second positioning data; and
   for a condition where the comparison is greater than a predetermined threshold, switch to operating in a third mode to generate additional positioning data.
46. The computer-implemented method of clause 45, wherein, while the user equipment is operating in the third mode, the user equipment implements the second process to generate the additional positioning data.
47. The computer-implemented method of clause 45, wherein, while the user equipment is operating in the third mode, the user equipment implements a third process to generate the additional positioning data.
48. The computer-implemented method of any of clauses 35-47, wherein the first process is a trained machine learning process.
49. The computer-implemented method of any of clauses 35-48, wherein the second process is a trained machine learning process
50. The computer-implemented method of any of clauses 35-49, wherein the reporting request includes a model parameter, wherein the model parameter identifies one or more processes to monitor, the one or more processes including the first process and the second process.
51. A positioning computing device comprising:
   a means for transmitting, by a processor of a location server, a reporting request for positioning data to a user equipment, wherein receipt of the reporting request by the user equipment causes the user equipment to perform operations in a first mode, the operations comprising:
      implementing a first process to generate first positioning data and implementing a second process to generate second positioning data; and
      generating reporting data indicative of a comparison between the first positioning data and the second positioning data; and
   a means for receiving, by the processor from the user equipment, the reporting data; and
   a means for based on the reporting data, generate and transmit, to the user equipment, an instruction, wherein the instruction causes the user equipment to implement at least one of the first process and the second process.
52. The positioning computing device of clause 51, wherein the reporting request includes a timing parameter, wherein the timing parameter identifies a time interval for the user equipment to operate in the first mode.
53. The positioning computing device of any of clauses 51-52, wherein the reporting request includes a resource parameter that identifies one or more resources for the user equipment to generate positioning data from.
54. The positioning computing device of clause 53, wherein the one or more resources includes a resource selected from a group comprising: resources associated with an assistance, resources associated with a positioning frequency layer (PFL), resources associated with a transmission reception (TRP) ID, resources associated with a positioning reference signal (PRS) resources, or combinations thereof.
55. The positioning computing device of any of clauses 51-54, wherein the first positioning data is associated with a first subset of resources and the second positioning data is associated with a second subset of resources.
56. The positioning computing device method of clause 55, wherein the second subset of resources includes the first subset of resources.
57. The positioning computing device of any of clauses 51-56, wherein the reporting request causes the user equipment to:
   generate a first timestamp associated with a first element of the one or more elements of the first positioning data and a second timestamp associated a second element of the one or more elements of the second positioning data, wherein the first element corresponds to the second element;
   compare the first timestamp with the second timestamp;
   determine the first timestamp and the second timestamp are within a predetermined temporal interval; and
   generate the reporting data based on the determination.
58. The positioning computing device of clause 57, wherein the reporting request further causes the user equipment to determine the first timestamp and the second timestamp match.
59. The positioning computing device of any of clauses 51-58, wherein the reporting request further causes the user equipment to simultaneously generate one or more elements of the first positioning data utilizing the first process and one or more elements of the second positioning data utilizing the second process.
60. The positioning computing device of clause 59, wherein the reporting request further causes the user equipment to:
   compare the first positioning data and the second positioning data;
   based on the comparison, determine that a difference between a first element of the first positioning data and a corresponding first element of the second positioning data satisfies a difference threshold; and
   transmit, to the processor of the location server, the reporting data based on the determined difference satisfying the difference threshold.
61. The positioning computing device of clause 60, wherein prior to receiving the reporting request from the processor of the location server, the user equipment operates in a second mode, and wherein the receipt of the reporting request by the user equipment causes the user equipment to:
   switch from operating in the second mode to the first mode;
   determine that at least the first element of the first positioning data and the corresponding first element of the second positioning data are within a predetermined time margin;
   compare at least the first element of the first positioning data and the corresponding first element of the second positioning data; and
   for a condition where the comparison is greater than a predetermined threshold, switch to operating in a third mode to generate additional positioning data.
62. The positioning computing device of clause 61, wherein, while the user equipment is operating in the third mode, the user equipment implements the second process to generate the additional positioning data.
63. The positioning computing device of clause 61, wherein, while the user equipment is operating in the third mode, the user equipment implements a third process to generate the additional positioning data.
64. The positioning computing device of any of clauses 51-63, wherein the first process is a trained machine learning process.
65. The positioning computing device of any of clauses 51-64, wherein the second process is a trained machine learning process.
66. The positioning computing device of any of clauses 51-65, wherein the reporting request includes a model parameter, wherein the model parameter identifies one or more processes to monitor, the one or more processes including the first process and the second process.
67. An apparatus, comprising:
   a non-transitory machine-readable storage medium storing instructions; and
   at least one processor coupled to the non-transitory machine-readable storage medium, the at least one processor being configured to execute the instructions to:
      transmit a reporting request for positioning data to a user equipment;
      receive reporting data indicative of a comparison between first positioning data generated from a first process and second positioning data generated from a second process; and
      based on the reporting data, generate and transmit, to the user equipment, an instruction that causes the user equipment to implement the first process.
68. The apparatus of clause 67, wherein the at least one processor is configured to execute the instructions further to:
   receive third positioning data from the user equipment;
   based on the third positioning data, generate and transmit, to the user equipment, a second instruction that causes the user equipment to implement the second process.
69. The apparatus of any of clauses 67-68, wherein the reporting request includes a timing parameter, the timing parameter identifies a time interval for the user equipment to operate in a first mode.
70. The apparatus of any of clauses 67-69, wherein the reporting request includes a resource parameter that identifies one or more resources for the user equipment to generate the positioning data from.
71. The apparatus of clause 70, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.
72. The apparatus of any of clauses 67-71, wherein the first positioning data is associated with a first subset of resources and the second positioning data is associated with a second subset of resources.
73. The apparatus of clause 72, wherein the second subset of resources includes the first subset of resources.
74. The apparatus of any of clauses 67-74, wherein the first positioning data and the second positioning data each include one or more elements associated with a same resource.
75. The apparatus of any of clauses 67-75, wherein the first process is a trained machine learning process.
76. the Apparatus of Any of Clauses 67-75, Wherein the Second Process Is a Trained Machine

learning process.
77. The apparatus of any of clauses 67-76, wherein the reporting request includes a model parameter, wherein the model parameter identifies one or more processes to monitor, the one or more processes including the first process and the second process.
78. A non-transitory, machine-readable storage medium storing instructions that, when executed by at least one processor of a server, causes the at least one processor to perform operations that include:
   transmitting a reporting request for positioning data to a user equipment;
   receiving reporting data indicative of a comparison between first positioning data generated from a first process and second positioning data generated from a second process; and
   based on the reporting data, generating and transmitting, to the user equipment, an instruction that causes the user equipment to implement the first process.
79. The non-transitory, machine-readable storage medium of clause 78, further comprising:
   receiving third positioning data from the user equipment;
   based on the third positioning data, generating and transmitting, to the user equipment, a second instruction that causes the user equipment to implement the second process.
80. The non-transitory, machine-readable storage medium of any of clauses 78-79, wherein the reporting request includes a timing parameter, the timing parameter identifies a time interval for the user equipment to operate in a first mode.
81. The non-transitory, machine-readable storage medium of any of clauses 78-80 wherein the reporting request includes a resource parameter that identifies one or more resources for the user equipment to generate the positioning data from.
82. The non-transitory, machine-readable storage medium of clause 81, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.
83. The non-transitory, machine-readable storage medium of any of clauses 78-82, wherein the first positioning data is associated with a first subset of resources and the second positioning data is associated with a second subset of resources.
84. The non-transitory, machine-readable storage medium of clause 83, wherein the second subset of resources includes the first subset of resources.
85. The non-transitory, machine-readable storage medium of any of clauses 78-84, wherein the first positioning data and the second positioning data each include one or more elements associated with a same resource.
86. The non-transitory, machine-readable storage medium of any of clauses 78-85, wherein the first process is a trained machine learning process.
87. The non-transitory, machine-readable storage medium of any of clauses 78-86, wherein the second process is a trained machine learning process.
88. The non-transitory, machine-readable storage medium of any of clauses 78-87, wherein the reporting request includes a model parameter, wherein the model parameter identifies one or more processes to monitor, the one or more processes including the first process and the second process.
89. A computer-implemented method, comprising:
   transmitting a reporting request for positioning data to a user equipment;
   receiving reporting data indicative of a comparison between first positioning data generated from a first process and second positioning data generated from a second process; and
   based on the reporting data, generating and transmitting, to the user equipment, an instruction that causes the user equipment to implement the first process.
90. The computer-implemented method of clause 89, further comprising:
   receiving third positioning data from the user equipment;
   based on the third positioning data, generating and transmitting, to the user equipment, a second instruction that causes the user equipment to implement the second process.
91. The computer-implemented method of any of clauses 89-90, wherein the reporting request includes a timing parameter, the timing parameter identifies a time interval for the user equipment to operate in a first mode.
92. The computer-implemented method of any of clauses 89-91 wherein the reporting request includes a resource parameter that identifies one or more resources for the user equipment to generate the positioning data from.
93. The computer-implemented method of clause 92, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.
94. The computer-implemented method of any of clauses 89-93, wherein the first positioning data is associated with a first subset of resources and the second positioning data is associated with a second subset of resources.
95. The computer-implemented method of clause 94, wherein the second subset of resources includes the first subset of resources.
95. The computer-implemented method of any of clauses 89-95, wherein the first positioning data and the second positioning data each include one or more elements associated with a same resource.
96. The computer-implemented method of any of clauses 89-95, wherein the first process is a trained machine learning process.
97. The computer-implemented method of any of clauses 89-96, wherein the second process is a trained machine learning process.
98. The computer-implemented method of any of clauses 89-97, wherein the reporting request includes a model parameter, wherein the model parameter identifies one or more processes to monitor, the one or more processes including the first process and the second process.
99. A positioning computing device, comprising:
   a means for transmitting a reporting request for positioning data to a user equipment;
   a means for receiving reporting data indicative of a comparison between first positioning data generated from a first process and second positioning data generated from a second process; and
   a means for, based on the reporting data, generating and transmitting, to the user equipment, an instruction that causes the user equipment to implement the first process.
100. The positioning computing device of clause 99, further comprising:
   a means for receiving third positioning data from the user equipment;
   a means for, based on the third positioning data, generating and transmitting, to the user equipment, a second instruction that causes the user equipment to implement the second process.
101. The positioning computing device of any of clauses 99-100, wherein the reporting request includes a timing parameter, the timing parameter identifies a time interval for the user equipment to operate in a first mode.
102. The positioning computing device of any of clauses 99-101 wherein the reporting request includes a resource parameter that identifies one or more resources for the user equipment to generate the positioning data from.
103. The positioning computing device of clause 102, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.
104. The positioning computing device of any of clauses 99-103, wherein the first positioning data is associated with a first subset of resources and the second positioning data is associated with a second subset of resources.
105. The positioning computing device of clause 104, wherein the second subset of resources includes the first subset of resources.
106. The positioning computing device of any of clauses 99-105, wherein the first positioning data and the second positioning data each include one or more elements associated with a same resource.
107. The positioning computing device of any of clauses 99-105, wherein the first process is a trained machine learning process.
108. The positioning computing device of any of clauses 99-106, wherein the second process is a trained machine learning process.
109. The positioning computing device of any of clauses 99-108, wherein the reporting request includes a model parameter, wherein the model parameter identifies one or more processes to monitor, the one or more processes including the first process and the second process.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including user equipment (UE) engine 208A, application 212B, application programming interface (API) 402, process module 404, analysis module 406, notification module 408, API 502, notification engine 520, and API 602, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, an application program, an engine, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

1. An apparatus, comprising:
a non-transitory machine-readable storage medium storing instructions; and at least one processor coupled to the non-transitory machine-readable storage medium, the at least one processor being configured to execute the instructions to:
transmit a reporting request for positioning data to a user equipment, wherein receipt of the reporting request by the user equipment causing the user equipment to perform operations in a first mode, the operations comprising:
implementing a first process to generate first positioning data, and implementing a second process to generate second positioning data; and generating reporting data indicative of a comparison between the first positioning data and the second positioning data;
receive, from the user equipment, the reporting data; and
based on the reporting data, generate and transmit, to the user equipment, an instruction, wherein the instruction causes the user equipment to implement at least one of the first process or the second process.

2. The apparatus of claim 1, wherein the reporting request includes a timing parameter, the timing parameter identifies a time interval for the user equipment to operate in the first mode.

3. The apparatus of claim 1, wherein the reporting request includes a resource parameter that identifies one or more resources for the user equipment to generate the positioning data from.

4. The apparatus of claim 3, wherein the one or more resources includes a resource selected from a group comprising: resources associated assistance data ID, resources associated with a positioning frequency layer (PFL) ID, resources associated with a transmission reception (TRP) ID, resources associated with positioning reference signal (PRS) set ID, a set of positioning reference signal (PRS) resources, or combinations thereof.

5. (canceled)

6. (canceled)

7. (canceled)

8. The apparatus of claim 1, wherein the first positioning data and the second positioning data each include one or more elements associated with a same resource, and wherein the reporting request causes the user equipment to:
generate a first timestamp associated with a first element of the one or more elements of the first positioning data and a second timestamp associated a second element of the one or more elements of the second positioning data, wherein the first element corresponds to the second element;
compare the first timestamp with the second timestamp;
determine the first timestamp and the second timestamp are within a predetermined temporal interval; and
generate the reporting data based on the determination.

9. (canceled)

10. The apparatus of claim 1, wherein the reporting request further causes the user equipment to:
simultaneously generate one or more elements of the first positioning data utilizing the first process and one or more elements of the second positioning data utilizing the second process.

11. The apparatus of claim 10, wherein the reporting request further causes the user equipment to:
compare the first positioning data and the second positioning data;
based on the comparison, determine that a difference between a first element of the first positioning data and a corresponding first element of the second positioning data satisfies a difference threshold; and
transmit, to the apparatus, the reporting data based on the determined difference satisfying the difference threshold.

12. The apparatus of claim 11, wherein prior to receiving the reporting request from the apparatus, the user equipment operates in a second mode and implements the first process to generate the first positioning data, and wherein the receipt of the reporting request by the user equipment causes the user equipment to:
switch from operating in the second mode to the first mode;
determine that at least the first element of the first positioning data and the corresponding first element of the second positioning data are within a predetermined time margin;
compare at least the first element of the first positioning data and the corresponding first element of the second positioning data; and
for a condition where the comparison is greater than a predetermined threshold, switch to operating in a third mode to generate additional positioning data.

13. (canceled)

14. (canceled)

15. (canceled)

16. (canceled)

17. The apparatus of claim 1, wherein the reporting request includes a model parameter, wherein the model parameter identifies one or more processes to monitor, the one or more processes including the first process and the second process.

18. A non-transitory, machine-readable storage medium storing instructions that, when executed by at least one processor of a location server, causes the at least one processor to perform operations that include:
transmitting a reporting request for positioning data to a user equipment, wherein receipt of the reporting request by the user equipment causes the user equipment to perform operations in a first mode, the operations comprising:
implementing a first process to generate first positioning data, and implementing a second process to generate second positioning data; and generating reporting data indicative of a comparison between the first positioning data and the second positioning data; and
receiving, from the user equipment, the reporting data; and
based on the reporting data, generate and transmit, to the user equipment, an instruction, wherein the instruction causes the user equipment to implement at least one of the first process and or second process.

19. A computer-implemented method, comprising:
transmitting, by a processor of a location server, a reporting request for positioning data to a user equipment, wherein receipt of the reporting request by the user equipment causes the user equipment to perform operations in a first mode, the operations comprising:
implementing a first process to generate first positioning data and implementing a second process to generate second positioning data; and generating reporting data indicative of a comparison between the first positioning data and the second positioning data; and
receiving, by the processor from the user equipment, the reporting data; and based on the reporting data, generate and transmit, to the user equipment, an instruction, wherein the instruction causes the user equipment to implement at least one of the first process and the second process.

20. The computer-implemented method of claim 19, wherein the reporting request includes a timing parameter, wherein the timing parameter identifies a time interval for the user equipment to operate in the first mode.

21. The computer-implemented method of claim 19, wherein the reporting request includes a resource parameter that identifies one or more resources for the user equipment to generate positioning data from.

22. The computer-implemented method of claim 21, wherein the one or more resources includes a resource selected from a group comprising: resources associated with an assistance, resources associated with a positioning frequency layer (PFL), resources associated with a transmission reception (TRP) ID, resources associated with a positioning reference signal (PRS) resources, or combinations thereof.

23. The computer-implemented method of claim 19, wherein the first positioning data is associated with a first subset of resources and the second positioning data is associated with a second subset of resources, wherein the second subset of resources includes the first subset of resources.

24. (canceled)

25. The computer-implemented method of claim 23, wherein the reporting request causes the user equipment to:
generate a first timestamp associated with a first element of the one or more elements of the first positioning data and a second timestamp associated a second element of the one or more elements of the second positioning data, wherein the first element corresponds to the second element;
compare the first timestamp with the second timestamp;
determine the first timestamp and the second timestamp are within a predetermined temporal interval; and
generate the reporting data based on the determination.

26. (canceled)

27. The computer-implemented method of claim 19, wherein the reporting request further causes the user equipment to simultaneously generate one or more elements of the first positioning data utilizing the first process and one or more elements of the second positioning data utilizing the second process.

28. The computer-implemented method of claim 27, wherein the reporting request further causes the user equipment to:
compare the first positioning data and the second positioning data;
based on the comparison, determine that a difference between a first element of the first positioning data and a corresponding first element of the second positioning data satisfies a difference threshold; and
transmit, to the processor of the location server, the reporting data based on the determined difference satisfying the difference threshold.

29. The computer-implemented method of claim 28, wherein prior to receiving the reporting request from the processor of the location server, the user equipment operates in a second mode, and wherein the receipt of the reporting request by the user equipment causes the user equipment to:
switch from operating in the second mode to the first mode;
determine that at least the first element of the first positioning data and the corresponding first element of the second positioning data are within a predetermined time margin;
compare at least the first element of the first positioning data and the corresponding first element of the second positioning data; and
for a condition where the comparison is greater than a predetermined threshold, switch to operating in a third mode to generate additional positioning data.

30. (canceled)

31. (canceled)

32. (canceled)

33. (canceled)

34. (canceled)

35. (canceled)
